(19) United States
(12) Patent Application Publication
(10) Pub. No.: US 2009/0061170 A1
(43) Pub. Date: Mar. 5, 2009

(54) ANISOTROPIC FILM AND METHOD OF MANUFACTURING ANISOTROPIC FILM

(75) Inventors: Shigenori Fujikawa, Wako-shi (JP); Wakana Kubo, Wako-shi (JP); Toyoki Kunitake, Wako-shi (JP); Hideo Hada, Kawasaki-shi (JP); Sanae Furuya, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignees: Tokyo Ohka Kogyo Co., Ltd., Kawasaki-shi (JP); Riken, Saitama-ken (JP)

(21) Appl. No.: 12/199,569

(22) Filed: Aug. 27, 2008

(30) Foreign Application Priority Data
Sep. 3, 2007 (JP) 2007-227934

(51) Int. Cl. B32B 3/10; B05D 5/00; B05D 3/00; B05D 3/10; H05H 1/24

(52) U.S. Cl. 428/195.1; 427/407.1; 427/331; 427/302; 427/539; 427/404

(57) ABSTRACT

An anisotropic film is disclosed in which a line-shaped nanostructure is disposed inside a resin film. Also disclosed is a method of producing an anisotropic film that includes: forming a metal nanostructure on a substrate, forming a resin film that embeds the metal nanostructure, and detaching the resin film from the substrate, wherein the step of forming the metal nanostructure on the substrate includes: at least, forming a coating film on the surface of a template provided on the substrate, the coating film including a metal layer formed by electroless plating; and removing a portion or all of the template while retaining a portion or all of the coating film, or removing a portion of the coating film. Also disclosed is an anisotropic film produced using the method of producing an anisotropic film.

### TECHNICAL FIELD

The present invention relates to an anisotropic film having a nanostructure within a resin film, and a method of producing an anisotropic film having a nanostructure that includes at least a metal layer.

This application claims priority from Japanese Patent Application No. 2007-227934 filed on Sep. 3, 2007, the disclosure of which is incorporated by reference herein.

### BACKGROUND ART

In recent years, techniques for fabricating microscopic structures have begun to show considerable promise for application in all manner of fields. In particular, structural bodies that include structures of nanometer size (so-called nanomaterials) exhibit different physical and chemical properties from their corresponding bulk materials, and are therefore attracting enormous interest, both from the fundamental research perspective and the applied research perspective. For example, nanomaterials having a hollow three dimensional structure such as a cylindrical shape are expected to have important roles in a variety of different fields, including inclusion chemistry, electrochemistry, materials science, biomedicine, sensors, catalysts and separation techniques. Furthermore, techniques for fabricating line-shaped micropatterns can be linked directly to the fabrication of integrated circuits and increased integration levels, and are therefore the subject of extremely intensive research and development in fields such as the semiconductor industry.

Conventional methods of producing microscopic structures include methods known as template methods, and methods that use lithography techniques. For example, Non-Patent Document 1 proposes a method of producing a nanomaterial having a spherical capsule-shaped hollow three dimensional structure by dispersing template microparticles in a solution, coating the surface of the template microparticles with a thin film, and then removing the template microparticles.

Further, the applicants of the present invention have proposed methods of producing nanostructures by coating the surface of a template having a nanopattern formed thereon with a metal oxide film or a composite film of a metal oxide with an organic compound, and then removing the template (see Patent Documents 1 and 2).

Examples of known methods of fabricating microscopic metal structures include (1) methods in which a lithography technique is used to form a microscopic pattern on top of a metal layer, and that microscopic pattern is then used as a mask for etching the metal layer, and (2) methods in which a metal plating technique is used to fill a microscopic pattern formed using a lithography technique.

However, using the methods proposed to date, fabricating a structure in which at least a portion of the structure has dimensions at the nanometer level (namely, a nanostructure), such as a structure composed of a metal layer having a thickness within a range from several nanometers to several tens of nanometers, has proven very difficult. For example, using a method (1) described above, not only is the actual formation of a nanosize pattern extremely difficult, but even if such a nanosize pattern were to be formed, the etching resistance of the pattern is low and the etching selectivity ratio relative to the metal substrate is poor, meaning obtaining a satisfactory nanostructure is problematic. Furthermore, a method (2) described above suffers from a similar problem to the method (1) in that actual formation of the microscopic pattern is extremely difficult, and moreover, conducting a plating treatment within such a microscopic pattern is also difficult. Formation of a structure with a large aspect ratio (the ratio of height relative to width) such as a line-shaped or columnar structure is particularly difficult.

On the other hand, in order to achieve further miniaturization and improved functionality for electronic devices and magnetic devices and the like, it is very important that the transmission of electrical signals and the like can be precisely controlled within restricted microspaces.

Anisotropic materials such as resin films that enable the transmission of electricity, heat, or the like only in specific directions are expected to be extremely useful in the type of transmission control mentioned above, and a multitude of anisotropic materials are therefore currently being actively researched. Examples of these types of anisotropic materials include metal fiber fabrics woven using microscopic metal threads with a diameter of several tens of microns to several hundred microns, and resin films containing suitably-oriented conductive polymers (see non-patent references 2 to 4).

[Non-Patent Document 1] Advanced Materials, 13(1), pp. 11 to 22 (2001)

[Patent Document 1]

Japanese Unexamined Patent Application, First Publication No. 2005-205584

[Patent Document 2]

Japanese Unexamined Patent Application, First Publication No. 2006-297575

[Non-Patent Document 2]

Lanticse and 7 others, Carbon, 44(14), pp. 3078 to 3086 (2006)

[Non-Patent Document 3]

Liu and 4 others, Journal of Materials Science, 42(6), pp. 2121 to 2125 (2007)

[Non-Patent Document 4] Yasushi Goto, “Anisotropic Conductive Film”, Hitachi Hyoron 89(05), pp. 52 to 57 (2007)

### DISCLOSURE OF THE INVENTION

### Problems to be Solved by the Invention

A metal fiber fabric exhibits excellent anisotropy because electricity or heat is conducted directly through the metal fibers, but because the metal fibers have a thickness at the micron level, they tend to suffer from high rigidity and poor workability. In contrast, a resin film containing an oriented-conductive polymer exhibits excellent workability and handling properties, but the resin film is merely a film having higher levels of electrical or heat conductivity in a specific direction as compared with other directions through the resin film, that is, the resin film is not a film which can transmit electricity or heat only in the specified direction.

The present invention takes the above circumstances into consideration, with an object of providing an anisotropic film that exhibits excellent anisotropy, and also has superior workability and handling properties.

### Means for Solving the Problems

In order to achieve the above object, the present invention adopts the aspects described below.

Namely, a first aspect of the present invention is an anisotropic film in which a line-shaped nanostructure is disposed inside a resin film.

A second aspect of the present invention is a method of producing an anisotropic film that includes: forming a metal nanostructure on a substrate; forming a resin film that embeds the metal nanostructure; and detaching the resin film from the substrate, wherein the step of forming the metal nanostructure on the substrate includes: at least, forming a coating film on the surface of a template provided on the substrate, the coating film including a metal layer formed by electroless plating; and removing a portion or all of the template while retaining a portion or all of the coating film.

A third aspect of the present invention is a method of producing an anisotropic film that includes: forming a metal nanostructure on a substrate; forming a resin film that embeds the metal nanostructure; and detaching the resin film from the substrate, wherein the step of forming the metal nanostructure on the substrate includes, at least, forming a coating film on the surface of a template provided on the substrate, the coating film containing a metal layer formed by electroless plating; and removing a portion of the coating film.

A fourth aspect of the present invention is an anisotropic film produced by the method of producing an anisotropic film according to the second aspect or third aspect described above.

### EFFECTS OF THE INVENTION

According to the present invention, an anisotropic film can be provided that exhibits excellent anisotropy, as well as superior workability and handling properties.

### BRIEF DESCRIPTION OF THE DRAWINGS

FIG. 1 is schematic illustration showing a first embodiment of the present invention.

FIG. 2 is a scanning electron microscope image of a gold nanoline structure-containing film obtained in Example 1. The upper left portion of the figure represents a partially enlarged view.

FIG. 3 is a graph showing the results of measuring the conductivity of the gold nanoline structure-containing film obtained in Example 1. The solid line in the graph represents the measurement results in a direction parallel to the gold nanoline structures, whereas the dotted line represents the measurement results in a direction perpendicular to the gold nanoline structures.

FIG. 4 is a scanning electron microscope image of a gold nanoline structure-containing film obtained in Example 2.

FIG. 5 is a scanning electron microscope image of a silver nanoline structure-containing film obtained in Example 3.

### DESCRIPTION OF THE REFERENCE SYMBOLS

1 . . . Substrate
11 . . . Template
21 . . . Coating Film
31 . . . Resin Film

### BEST MODE FOR CARRYING OUT THE INVENTION

### Anisotropic Film

An anisotropic film of the first aspect of the present invention has a line-shaped nanostructure disposed inside a resin film.

In the present description and claims, the term “anisotropic film” means a film whose physical properties such as the electrical conductivity or thermal conductivity vary depending on the film direction.

In the present invention, a “line-shaped nanostructure” describes a line-shaped structure in which at least a portion of the cross-sectional shape are at the nanometer level. Here, the term “line-shaped” means a continuous, unbroken shape like a thread, which may be a straight line, a curved line, or a shape that includes kink structures. Further, there are no particular restrictions on the cross-sectional shape, as long as the overall nanostructure is line-shaped. Examples of the cross-sectional shape include rectangular, U-shaped, circular and elliptical shapes. In terms of suitability for use within the method of producing an anisotropic film according to the second aspect of the present invention described below, the cross-sectional shape is preferably rectangular or U-shaped.

In those cases where the cross-sectional shape of the nanostructure is either rectangular or U-shaped, the length across the shortest side of the cross-sectional shape is a nanometer level dimension, in those cases where the cross-sectional shape is circular, the cross-sectional diameter is a nanometer level dimension, and in those cases where the cross-sectional shape is an elliptical shape, the minor axis within the cross-section is a nanometer level dimension.

If the cross-sectional shape is rectangular, then the width of the cross-section is preferably within a range from 10 to 100 nm, and is more preferably from 50 to 70 nm. On the other hand, if the width of the cross-section is a nanometer level dimension, then the height of the cross-section needs not necessarily be a nanometer level dimension, but is preferably within a range from 10 to 1,000 nm, and more preferably from 50 to 600 nm.

If the cross-sectional shape is U-shaped, then the width from the inner periphery to the outer periphery of the U-shaped cross-section is preferably within a range from 10 to 100 nm, and more preferably from 50 to 70 nm.

The line-shaped nanostructure disposed inside the resin film may be either a single structure or a plurality of structures. In the case of a plurality of structures, there are no particular restrictions on the positioning of each nanostructure, as long as the anisotropy is able to be maintained, and all of the nanostructures may be positioned in parallel, positioned in a radial-type arrangement, or positioned randomly.

Furthermore, in order to generate a start point and end point in those cases where heat or electricity is to be conducted through the resin, the two ends of the line-shaped nanostructure are preferably exposed at the side surfaces of the resin film. The line-shaped nanostructure may be either completely embedded within the resin film with the exception of the two end portions, or a portion of the nanostructure may be exposed at the resin film surface.

There are no particular restrictions on the line-shaped nanostructure, provided it is a structure that is capable of imparting the resin film with some form of physical anisotropy such as electrical conductivity anisotropy or thermal conductivity anisotropy, and the nanostructure may be formed from a single material or from a plurality of different materials. For example, the structure may be formed solely from a metal, may be formed from a metal and another material, or may be formed solely from a material other than a metal. Examples of materials other than metals that may be used include metal oxides, organic compounds, and inorganic compounds. In the case of a structure formed from a material other than a metal, the structure preferably includes a material that exhibits excellent electrical conductivity or thermal conductivity, such as a conductive polymer.

This type of anisotropic film can be produced by using the method of producing an anisotropic film according to the second or third aspect of the present invention described below. In the method of producing an anisotropic film according to the second or third aspect of the present invention, a metal layer is indispensable in the step of forming a coating film, but in the production of an anisotropic film according to the first aspect of the present invention, the coating film that is formed may be a film composed solely of a metal layer, a film composed of a metal layer and a layer other than a metal layer, or a film composed of a layer other than a metal layer. Examples of the layer other than a metal layer include those referred to as “another layer” in the following description of the method of producing an anisotropic film according to the second and third aspects of the present invention. In those cases where a coating film composed of a layer other than a metal layer is formed, a material that exhibits excellent electrical conductivity or thermal conductivity, such as a conductive polymer, is preferably used as the material for forming the layer.

In those cases where a nanostructure of excellent electrical conductivity or thermal conductivity (hereinafter also referred to as a “conductive nanostructure”), wherein a metal, a conductive polymer, or the like is used as the material, is deposited inside a resin film, heat or electricity is transmitted through the resin film only via the medium of the conductive nanostructure. As a result, an anisotropic film having a line-shaped conductive nanostructure disposed within the resin film exhibits excellent anisotropy, with heat or electricity able to be conducted through the resin film in only a specific direction that corresponds with the positioning of the conductive nanostructure. For example, by positioning a plurality of line-shaped conductive nanostructures in a mutually parallel arrangement within a resin film, an anisotropic film having electrical conductivity anisotropy or thermal conductivity anisotropy can be produced, in which heat or electricity is able to be conducted through the resin film in a direction parallel to the nanostructures, but undergoes absolutely no conduction in a direction perpendicular to the nanostructures. In another example, even if a plurality of line-shaped conductive nanostructures are arranged randomly or in a radial arrangement within a resin film, an anisotropic film which can conduct heat or electricity only from one end of a conductive nanostructure to the other end, namely, only in a specific direction within the resin film can be produced.

Furthermore, by suitable positioning of the line-shaped nanostructures inside the resin film, anisotropic films with a variety of optical properties and magnetic properties can be obtained.

For example, if the line-shaped nanostructures are positioned in parallel with a suitable equidistant spacing between structures, then the film can be used as a polarizing element such as a polarizing film. It is assumed that because incident light entering the anisotropic film is transmitted through the resin portion between two nanostructures, the nanostructures are able to perform the role of a slit.

If a nanostructure in which the surface is formed from a metal material is arranged regularly, such as in parallel, within the resin film, then the resin film can be used as an optical element such as a light emitting device or a biosensor. It is thought that this is because arranging the nanostructures regularly in a microscopic area within the resin film yields a surface plasmon resonance effect.

By arranging line-shaped nanostructures that have a U-shaped cross-section and a surface formed from a metal material in a regular manner, such as in parallel, within the resin film, an anisotropic film can be produced that functions as a metamaterial having a negative refractive index.

Moreover, by forming the nanostructures that are arranged within the anisotropic film from a material having magnetic properties, such as nickel, an anisotropic film with magnetic properties can be produced.

In addition, even in those cases where the nanostructures positioned within the anisotropic film are nanostructures formed from non-metal materials, the resulting film can still be used as a polarizing element. It is thought that this is because the presence of the nanostructures yields a suitable degree of unevenness within the resin film.

### <<Method of Producing Anisotropic Film>>

A method of producing an anisotropic film according to the second aspect of the present invention hereinafter also referred to as the “production method (1)” of the present invention) includes: forming a metal nanostructure on a substrate; forming a resin film that embeds the metal nanostructure; and detaching the resin film from the substrate, wherein the step of forming the metal nanostructure on the substrate includes: at least, forming a coating film on the surface of a template provided on the substrate, the coating film including a metal layer formed by electroless plating; and removing a portion or all of the template while retaining a portion or all of the coating film.

Each of the above steps and the materials used within those steps will be described below in detail.

### <Substrate, Template>

In the production method (1) of the present invention, first, a substrate with a template provided thereon is prepared.

There are no particular restrictions on the substrate, as long as a template is able to formed on top of the substrate, and typical examples of the substrate include substrates composed of a metal such as silicon, copper, chrome, iron, or aluminum; substrates composed of an inorganic material such as glass, titanium dioxide, silica, or mica; and substrates composed of an organic compound such as an acrylic sheet, polystyrene, cellulose, cellulose acetate or a phenolic resin. Further, an organic or inorganic antireflective film may be provided on the surface of the substrate.

Particularly, silicon substrates, graphite, Teflon (a registered trademark), acrylic sheets, polystyrene or phenolic resins or the like are preferred as the substrate, because a metal layer is hardly formed on the substrate surface, and can be formed with greater selectively on the surface of the template (indicating excellent plating selectivity) when electroless plating is performed.

There are no particular restrictions on the size and shape of the substrate. The substrate need not necessarily have a flat surface, and substrates of all manner of materials and shapes may be selected appropriately. Namely, all manner of substrates can be used, including substrates having a curved surface, flat sheets, and thin flakes having an uneven surface.

There are no particular restrictions on the template, provided the purpose of the present invention is retained. Examples of templates that may be employed include templates formed using a lithography process, templates formed using a contact printing process, templates formed using an imprinting process, templates formed using a mechanical micromachining process, templates formed via LIGA (LIthographie, Galvanoforming und Abformung), and templates formed by beam writing. Of these, templates formed using a lithography process are preferred.

Furthermore, a template prepared by subjecting the surface of an aforementioned template to a physical treatment and/or a chemical treatment may also be used as the template. Examples of the physical and/or chemical treatment include polishing, adhesion operations that involve forming a thin film or the like on the template surface, plasma treatments, solvent treatments, chemical decomposition of the template surface, heat treatments, and drawing treatments.

There are no particular restrictions on the shape and size of the template, which may be determined appropriately in accordance with the shape and size of the target structure.

Specific examples of template shapes that can be employed include rectangular shapes, circular columns, holes, lines, network structures or branched structures including such shapes, polygonal shapes and composite or repeating structures thereof, circuit-like structures such as those seen in integrated circuits, and lattice shapes.

For example, in a case where a line-shaped structure is to be formed, a line pattern having a rectangular cross-section is preferably formed as the template. In such a case, as described below, by forming a coating film on the template surface, a line-shaped structure with a U-shaped cross-section is formed (namely, a line in which the height and width of the inner periphery of the U-shape is the same as the height and width of the template, and the width from the outer periphery to the inner periphery of the U-shape is the thickness of the coating film). On the other hand, if a coating film is formed on the template surface, the top portion of the coating film is removed, and the template is then removed, then only the side wall portions of the coating film remain on top of the substrate. As a result, line-shaped structures having a rectangular cross-section (namely, lines in which the line width is equivalent to the thickness of the coating film, and the line height is equivalent to the height of the remaining side wall portions) are formed on the substrate.

Furthermore, in a case where a cylindrical structure is to be formed, a hole pattern or columnar pattern is preferably formed as the template. In such a case, as described below, if a coating film is formed on the template surface, the top portion of the coating film is removed, and the template is then removed, then only the side wall portions of the coating film remain on top of the substrate. As a result, a cylindrical structure having an outer diameter equivalent to the inner diameter of the hole pattern is obtained.

There are no particular restrictions on the material used for forming the template (the template-forming material), and any material may be selected that is suitable for the pattern formation method being used. Template-forming materials that can be used favorably in the present invention are described below.

### [Template-Forming Material]

In the present invention, as the material used for forming the template (the template-forming material), template-forming materials containing an organic compound with a molecular weight of at least 500 can be used favorably. Provided the molecular weight of this organic compound is at least 500, a template with superior strength and shape can be formed. Further, a template of nanolevel size can be formed more readily. Furthermore, a template formed using such a template-forming material also offers the advantage of being readily removable by etching with hydrogen gas or the like.

As this organic compound, the types of compound typically used as the base component of film-forming materials can be used. Here, the term “base component” describes an organic compound having a film-forming ability.

The above organic compounds can be broadly classified into low molecular weight organic compounds having a molecular weight of at least 500 but not more than 2,000 (hereinafter also referred to as “low-molecular compounds”), and high molecular weight compounds having a molecular weight that is greater than 2,000. As the low-molecular compound, a non-polymer is typically used. As the high-molecular compound, a resin (a polymer or copolymer) is typically used, and in such cases, the “molecular weight” refers to the polystyrene equivalent weight average molecular weight determined by GPC (gel permeation chromatography). Hereinafter, those cases where the simplified term “resin” is used refer to cases in which the molecular weight is 2,000 or greater.

A compound having a hydrophilic group is preferred as the organic compound, as it facilitates formation of a metal layer on the template surface.

As this hydrophilic group, one or more groups selected from the group consisting of a hydroxyl group, carboxyl group, carbonyl group, ester group, amino group and amide group is preferably used. Of these groups, a hydroxyl group (and particularly an alcoholic hydroxyl group or phenolic hydroxyl group), a carboxyl group, or an ester group is particularly preferred. Of these, one or more groups selected from the group consisting of a carboxyl group, alcoholic hydroxyl group, and phenolic hydroxyl group is particularly desirable.

In those cases where the organic compound is a high-molecular compound, the compound preferably contains at least 0.2 equivalents, and more preferably 0.5 to 0.8 equivalents, of the hydrophilic group. This means that when the high-molecular compound is composed of a structural unit having the hydrophilic group and other structural units, the former structural unit represents at least 20 mol %, and more preferably 50 to 80 mol % of all the structural units.

In those cases where the organic compound is a low-molecular compound, each molecule of the low-molecular compound preferably includes 1 to 20 equivalents, and more preferably 2 to 10 equivalents, of the hydrophilic group. Here, the expression “each molecule includes 1 to 20 equivalents of the hydrophilic group” means that 1 to 20 hydrophilic groups exist within a single molecule of the compound.

In terms of the method used for forming the template, as described above, a lithography process is preferred.

In a lithography process, a resist composition is used, which is a material that exhibits radiation sensitivity. There are no particular restrictions on this resist composition, and any of the conventional resist compositions that have been proposed may be appropriately selected and used. These resist compositions include positive resist compositions in which the alkali solubility increases upon exposure, and negative resist compositions in which the alkali solubility decreases upon exposure. In the present invention, a positive resist composition is particularly preferred.

As the resist composition, a chemically amplified resist composition including a base component (A) that exhibits changed solubility in an alkali developing solution under the action of acid (hereafter also referred to as “component (A)”) and an acid generator component (B) that generates acid upon exposure (hereafter also referred to as “component (B)”) is preferred, as such a composition exhibits superior levels of sensitivity and resolution and the like.

There are no particular restrictions on the chemically amplified resist composition, which may be selected appropriately from the multitude of chemically amplified resist compositions that have already been proposed. A typical chemically amplified resist composition includes a base component (A′) that exhibits changed solubility in an alkali developing solution under the action of acid (hereafter also referred to as “component (A′)”) and an acid generator component (B′) that generates acid upon irradiation with some form of radiation (hereafter also referred to as “component (B′)”).

When the chemically amplified resist composition is a negative resist composition, a base component that exhibits reduced solubility in an alkali developing solution under the action of acid is used as the component (A′), and a cross-linking agent is also blended with the negative resist composition.

In the negative resist composition, when acid is generated from the component (B′) upon exposure, the action of this acid causes cross-linking between the component (A′) and the cross-linking agent, and the component (A)′ changes from an alkali-soluble state to an alkali-insoluble state. Accordingly, if an organic film (resist film) obtained by applying the negative resist composition to a substrate is selectively exposed, then the exposed portions become alkali-insoluble, whereas the unexposed portions remain alkali-soluble. As a result, only the unexposed portions are removed by a developing treatment with alkali, thereby forming a resist pattern (the template).

As the component (A′) of the negative resist composition, an alkali-soluble resin is generally used. As the alkali-soluble resin, it is preferable to use a resin having a structural unit derived from at least one of an α-(hydroxyalkyl)acrylic acid and a lower alkyl ester of an α-(hydroxyalkyl)acrylic acid, as such a resin enables formation of a satisfactory resist pattern with minimal swelling. Here, the term “α-(hydroxyalkyl) acrylic acid” refers to one or both of acrylic acid, in which a hydrogen atom is bonded to the carbon atom on the α-position having the carboxyl group bonded thereto, and the α-hydroxyalkylacrylic acid, in which a hydroxyalkyl group (and preferably a hydroxyalkyl group of 1 to 5 carbon atoms) is bonded to the carbon atom on the α-position.

As the cross-linking agent, an amino-based cross-linking agent such as a glycoluril having a methylol group or alkoxymethyl group is generally preferable, as it enables formation of a resist pattern with minimal swelling. The quantity of the cross-linking agent added is preferably within a range of 1 to 50 parts by weight per 100 parts by weight of the alkali-soluble resin.

When the chemically amplified resist composition is a positive resist composition, a base component that has acid dissociable, dissolution inhibiting groups and exhibits increased solubility in an alkali developing solution under the action of acid is used as the component (A′).

The positive resist composition is alkali-insoluble prior to exposure, and when acid is generated from the component (B′) upon exposure, the acid dissociable, dissolution inhibiting groups are dissociated by the action of the generated acid, and the component (A′) becomes alkali-soluble. Accordingly, in the formation of a resist pattern, by conducting selective exposure of a resist film obtained by applying the positive resist composition onto a substrate, the exposed portions become alkali-soluble, whereas the unexposed portions remain alkali-insoluble. As the result, only the exposed portions are removed by an developing treatment with alkali, thereby forming a resist pattern.

The acid dissociable, dissolution inhibiting group is a group that exhibits an alkali dissolution inhibiting effect that renders the entire component (A′) alkali-insoluble prior to exposure, but then dissociates under the action of the acid generated from the acid generator (B′) following exposure, causing the entire component (A′) to change to an alkali-soluble state. There are no particular restrictions on the acid dissociable, dissolution inhibiting group, which may be selected appropriately from groups typically used within conventional chemically amplified positive resist compositions.

As the component (A′) of the positive resist composition, a component (A′-1) and/or a component (A′-2) described below are particularly preferred. The hydrophilic group may also act as the acid dissociable, dissolution inhibiting group.

Component (A′-1): a resin having an acid dissociable, dissolution inhibiting group.
Component (A′-2): a low-molecular compound having an acid dissociable, dissolution inhibiting group.

Preferred embodiments of the component (A′-1) and the component (A′-2) are described below in more detail.

### [Component (A′-1)]

As the component (A′-1), resins that contain a structural unit having an acid dissociable, dissolution inhibiting group can be exemplified, and resins containing a structural unit having an acid dissociable, dissolution inhibiting group and a structural unit having a hydrophilic group are preferred.

In the resin, the proportion of the structural unit having an acid dissociable, dissolution inhibiting group, relative to the combined total of all the structural units that constitute the resin, is preferably within a range from 20 to 80 mol %, more preferably from 20 to 70 mol %, and still more preferably from 30 to 60 mol %.

The proportion within the resin of the structural unit having a hydrophilic group, relative to the combined total of all the structural units that constitute the resin, is preferably within a range from 20 to 80 mol %, more preferably from 20 to 70 mol %, and still more preferably from 20 to 60 mol %.

The structural unit having a hydrophilic group is preferably a structural unit having a carboxyl group, alcoholic hydroxyl group or phenolic hydroxyl group, and is more preferably a unit derived from acrylic acid, methacrylic acid, an (α-lower alkyl) acrylate ester having an alcoholic hydroxyl group, or hydroxystyrene.

Specific examples of resins that can be used favorably as the component (A′-1) include novolak resins, hydroxystyrene-based resins, (α-lower alkyl) acrylate ester resins and copolymer resins that include a structural unit derived from hydroxystyrene and a structural unit derived from an (α-lower alkyl) acrylate ester, wherein the resins contain acid dissociable, dissolution inhibiting groups.

In the present description, a “lower alkyl group” means an alkyl group of 1 to 5 carbon atoms.

In the present description, a “hydroxystyrene-based resin” is a resin that includes a structural unit derived from either hydroxystyrene or an ester thereof, and includes no structural units derived from an (α-lower alkyl) acrylate ester.

An “(α-lower alkyl) acrylate ester resin” is a resin that includes a structural unit derived from an (α-lower alkyl) acrylate ester, and includes no structural units derived from hydroxystyrene or an ester thereof.

A “structural unit derived from hydroxystyrene” refers to a structural unit formed by cleavage of the ethylenic double bond of hydroxystyrene or an α-lower alkyl hydroxystyrene, and hereafter, may also be referred to as a “hydroxystyrene unit”. An “α-lower alkyl hydroxystyrene” describes a compound in which a lower alkyl group is bonded to the carbon atom to which the phenyl group is bonded.

The term “(α-lower alkyl) acrylic acid” refers to one or both of acrylic acid (CH₂═CH—COOH) and an α-lower alkyl acrylic acid.

An α-lower alkyl acrylic acid refers to a compound in which the hydrogen atom bonded to the carbon atom that is bonded to the carbonyl group of acrylic acid is substituted with a lower alkyl group.

An “(α-lower alkyl) acrylate ester” is an ester derivative of the “(α-lower alkyl) acrylic acid”, and refers to one or both of the acrylate ester and the α-lower alkyl acrylate ester.

A “structural unit derived from an (α-lower alkyl) acrylate ester” refers to a structural unit formed by cleavage of the ethylenic double bond of the (α-lower alkyl) acrylate ester, and hereinafter, may also be referred to as an “(α-lower alkyl) acrylate structural unit”. The term “(α-lower alkyl)acrylate” refers to one or both of the acrylate and the α-lower alkyl acrylate.

In a “structural unit derived from an α-lower alkyl hydroxystyrene” and a “structural unit derived from an α-lower alkyl acrylate ester”, the lower alkyl group bonded at the α-position is typically an alkyl group of 1 to 5 carbon atoms, is preferably a linear or branched alkyl group, and specific examples include a methyl group, ethyl group, propyl group, isopropyl group, n-butyl group, isobutyl group, tert-butyl group, pentyl group, isopentyl group and neopentyl group. From an industrial perspective, a methyl group is preferred.

Although there are no particular restrictions on preferred resin components for the component (A′-1), examples include component (A″-11) and component (A′-12) described below.

### [Component (A′-11)]

Component (A′-11) is a resin containing a structural unit having a phenolic hydroxyl group and a structural unit having an acid dissociable, dissolution inhibiting group, and where necessary, the resin may also include an alkali-insoluble structural unit.

An example of the structural unit having a phenolic hydroxyl group is the structural unit (a′1) described below.

Examples of the structural unit having an acid dissociable, dissolution inhibiting group include the structural unit (a′2) and the structural unit (a′3) described below.

An example of the alkali-insoluble structural unit is the structural unit (a′4) described below.

—Structural Unit (a′1)

The structural unit (a′1) is a structural unit derived from hydroxystyrene, and is preferably a structural unit represented by General Formula (I′) shown below.

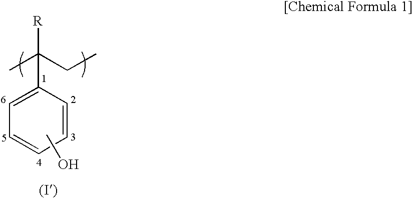

[wherein, R represents a hydrogen atom, an alkyl group of 1 to 5 carbon atoms, a halogen atom, or a halogenated alkyl group.]

Specific examples of the alkyl group for R include lower linear or branched alkyl groups such as a methyl group, ethyl group, propyl group, isopropyl group, n-butyl group, isobutyl group, tert-butyl group, pentyl group, isopentyl group or neopentyl group. Examples of the halogen atom for R include a fluorine atom, chlorine atom, bromine atom or iodine atom. Examples of the halogenated alkyl group for R include groups in which a part or all of the hydrogen atoms within an aforementioned alkyl group of 1 to 5 carbon atoms have been substituted with the above halogen atoms.

R is preferably either a hydrogen atom or a lower alkyl group, and from the viewpoint of industrial availability, is most preferably a hydrogen atom or a methyl group.

This definition of R also applies below.

There are no particular restrictions on the bonding position of the —OH group to the benzene ring, although the position labeled 4 in the formula (the para position) is preferred.

The structural unit (a′1) may use either a single type of structural unit, or a combination of two or more different structural units.

The proportion of the structural unit (a′1) within the component (A′-11), relative to the combined total of all the structural units that constitute the component (A′-11), is preferably within a range from 40 to 80 mol %, and more preferably from 50 to 75 mol %. By ensuring that this proportion is at least 40 mol %, the solubility in alkali developing solutions can be improved, and a favorable improvement in the pattern shape can also be obtained. Ensuring the proportion is not more than 80 mol % enables a favorable balance to be achieved with the other structural units.

—Structural Unit (a′2)

The structural unit (a′2) is represented by General Formula (II′) shown below.

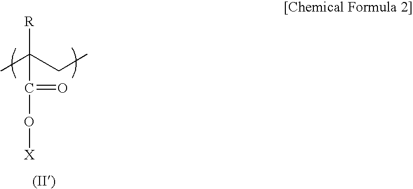

[wherein, R is as defined above, and X represents an acid dissociable, dissolution inhibiting group.]

Examples of the group X include acid dissociable, dissolution inhibiting groups that are alkyl groups having a tertiary carbon atom in which the tertiary carbon atom of that tertiary alkyl group is bonded to the ester group [—C(O)O—], as well as cyclic acetal groups such as a tetrahydropyranyl group and tetrahydrofuranyl group.

As group X, groups other than those described above can also be used, arbitrarily selected from acid dissociable, dissolution inhibiting groups typically used within chemically amplified positive resist compositions.

As the structural unit (a′2), units such as those represented by General Formula (III′) shown below are preferred.

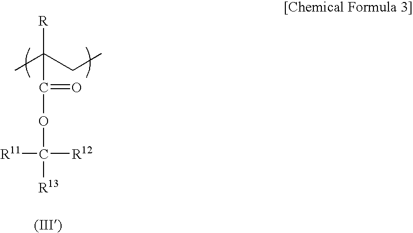

In this formula, R is as defined above; R¹¹, R¹² and R¹³ each independently represents an alkyl group (which may be linear or branched, and is preferably an alkyl group of 1 to 5 carbon atoms). Further, of the groups R¹¹, R¹² and R¹³, R¹¹ may represent a lower alkyl group, and R¹² and R¹³ may be bonded together to form a monocyclic or polycyclic aliphatic cyclic group. The number of carbon atoms within the aliphatic cyclic group is preferably from 5 to 12. Furthermore, of the groups R¹¹, R¹², and R¹³, R¹¹ and R¹² may be lower alkyl groups, and R¹³ may be a monocyclic or polycyclic aliphatic cyclic group. The number of carbon atoms within the aliphatic cyclic group is preferably from 5 to 12.

In this description and the claims, the term “aliphatic” is a relative concept used in relation to the term “aromatic”, and defines a group or compound or the like that contains no aromaticity. An “aliphatic cyclic group” refers to a monocyclic or polycyclic group that has no aromaticity.

Examples of the structure of the basic ring of the aliphatic cyclic group, exclusive of a substituent group, include groups composed solely of carbon atoms and hydrogen atoms (namely, aliphatic hydrocarbon groups), and aliphatic heterocyclic groups in which at least one carbon atom within the ring structure of an aforementioned aliphatic hydrocarbon group has been substituted with a hetero atom.

The aliphatic hydrocarbon group may be either saturated or unsaturated, but is preferably saturated. Examples of the aliphatic hydrocarbon group include groups in which one or more hydrogen atoms have been removed from a monocycloalkane, and groups in which one or more hydrogen atoms have been removed from a polycycloalkane such as a bicycloalkane, tricycloalkane or tetracycloalkane. Specific examples include groups in which one or more hydrogen atoms have been removed from a monocycloalkane such as cyclopentane or cyclohexane, and groups in which one or more hydrogen atoms have been removed from a polycycloalkane such as adamantane, norbornane, isobornane, tricyclodecane or tetracyclododecane. A part or all of the hydrogen atoms within these groups may be substituted with a substituent group (such as a lower alkyl group, fluorine atom or fluoroalkyl group).

In those cases where R¹¹, R¹² and R¹³ do not include an aliphatic cyclic group, it is preferable that R¹¹, R¹² and R¹³ be all methyl groups.

In those cases where R¹¹, R¹² and R¹³ do include an alicyclic group, then in those cases where the aliphatic cyclic group is a monocyclic aliphatic cyclic group, units having a cyclopentyl group or cyclohexyl group are preferred as the structural unit (a′2).

In those cases where the aliphatic cyclic group is a polycyclic aliphatic cyclic group, examples of preferred structural units (a′2) include those represented by General Formula (IV′) shown below.

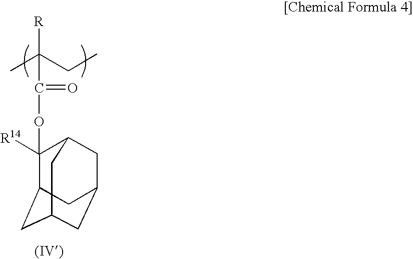

[wherein, R is as defined above, and R¹⁴ represents an alkyl group (which may be linear or branched, and is preferably an alkyl group of 1 to 5 carbon atoms).]

Furthermore, as a structural unit having an acid dissociable, dissolution inhibiting group that includes a polycyclic aliphatic cyclic group, units represented by a general formula (V′) shown below are preferred.

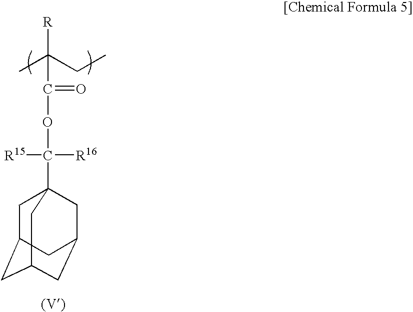

[wherein, R is as defined above, and R¹⁵ and R¹⁶ each independently represents an alkyl group (which may be linear or branched, and is preferably an alkyl group of 1 to 5 carbon atoms).]

The structural unit (a′2) may use either a single type of structural unit, or a combination of two or more different structural units.

The proportion of the structural unit (a′2) within the component (A′-11) is preferably within a range from 5 to 50 mol %, more preferably from 10 to 40 mol %, and still more preferably from 10 to 35 mol %.

—Structural Unit (a′3)

The structural unit (a′3) is a unit represented by a general formula (VI′) shown below.

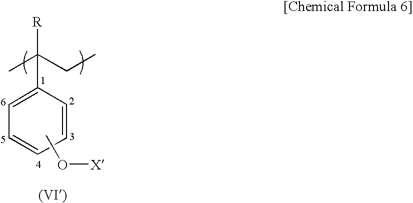

[wherein, R is as defined above, and X′ represents an acid dissociable, dissolution inhibiting group.]

Examples of X′ include tertiary alkyloxycarbonyl groups such as a tert-butyloxycarbonyl group or tert-pentyloxycarbonyl group; tertiary alkyloxycarbonylalkyl groups such as a tert-butyloxycarbonylmethyl group or tert-butyloxycarbonylethyl group; tertiary alkyl groups such as a tert-butyl group or tert-pentyl group; cyclic acetal groups such as a tetrahydropyranyl group or tetrahydrofuranyl group; and alkoxyalkyl groups such as an ethoxyethyl group or methoxypropyl group. Of these groups, a tert-butyloxycarbonyl group, tert-butyloxycarbonylmethyl group, tert-butyl group, tetrahydropyranyl group or ethoxyethyl group is preferred.

In addition to the groups listed above, the group X′ may also use other acid dissociable, dissolution inhibiting groups typically used in chemically amplified positive resist compositions.

In the general formula (VI′), there are no particular restrictions on the bonding position of the group (—OX′) bonded to the benzene ring, although bonding at the position labeled 4 in the above formula (the para position) is preferred.

The structural unit (a′3) may use either a single type of structural unit, or a combination of two or more different structural units.

The proportion of the structural unit (a′3) within the component (A′-11) is preferably within a range from 5 to 50 mol %, more preferably from 10 to 40 mol %, and still more preferably from 10 to 35 mol %.

—Structural Unit (a′4)

The structural unit (a′4) is represented by a general formula (VII′) shown below.

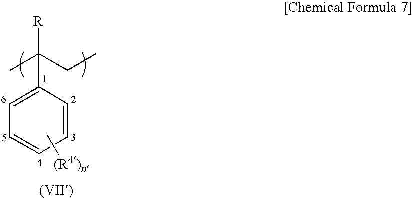

[wherein, R is as defined above, R^{4′} represents a lower alkyl group, and n′ represents either 0 or an integer from 1 to 3.]

The lower alkyl group for R^{4′} may be either a linear or branched group, and preferably contains 1 to 5 carbon atoms.

n′ is either 0 or an integer from 1 to 3, and is preferably 0.

The structural unit (a′4) may use either a single type of structural unit, or a combination of two or more different structural units.

The proportion of the structural unit (a′4) within the component (A′-11) is typically within a range from 1 to 40 mol %, and is preferably from 5 to 25 mol %. By ensuring this quantity is at least 1 mol %, the level of improvement in the shape (and particularly the improvement in thickness loss) is enhanced, whereas ensuring the quantity is not more than 40 mol % enables a favorable balance to be achieved with the other structural units.

The component (A′-11) must include the structural unit (a′1) and at least one structural unit selected from the group consisting of the structural unit (a′2) and the structural unit (a′3), and may also contain the structural unit (a′4). Furthermore, a copolymer containing all of the structural units may be used, or a mixture of a plurality of different polymers each containing at least one of the structural units may be used. Combinations of these two possibilities are also possible.

Furthermore, the component (A′-11) may also include other units besides the structural units (a′1), (a′2), (a′3) and (a′4) described above, although the structural units (a′1), (a′2), (a′3) and (a′4) preferably represent at least 80 mol %, more preferably at least 90 mol % (and most preferably 100 mol %) of the component (A′-11).

As the component (A′-11), the use of “a single copolymer containing the structural units (a′1) and (a′3), or a mixture of two or more different copolymers of this type”, or “a copolymer containing the structural units (a′1), (a′2) and (a′4), or a mixture of two or more different copolymers of this type”, or a mixture of these two configurations offers a simple way of achieving the desired effects, and is therefore the most desirable. Furthermore, such configurations are also preferred in terms of the improvement in the heat resistance.

A mixture of a polyhydroxystyrene protected with tertiary alkyloxycarbonyl groups and a polyhydroxystyrene protected with 1-alkoxyalkyl groups is particularly desirable. When mixing these two components, the mixing ratio (weight ratio) between the two polymers (namely, polyhydroxystyrene protected with tertiary alkyloxycarbonyl groups/polyhydroxystyrene protected with 1-alkoxyalkyl groups) is typically within a range from 1/9 to 9/1, is preferably from 2/8 to 8/2, and is more preferably from 2/8 to 5/5.

### [Component (A′-12)]

The component (A′-12) is an (α-lower alkyl) acrylate ester resin containing acid dissociable, dissolution inhibiting groups, for example, a resin containing a structural unit (a′5) derived from an (α-lower alkyl) acrylate ester that contains an acid dissociable, dissolution inhibiting group.

In the component (A′-12), when the acid dissociable, dissolution inhibiting groups dissociate under the action of the acid generated from the component (B′), carboxyl groups are generated and the alkali solubility of the resin increases. Further, the existence of these generated carboxyl groups facilitates the formation of a metal layer on the resist pattern.

—Structural Unit (a′5)

As the acid dissociable, dissolution inhibiting group, for example, any of the multitude of groups that have been proposed for the resins used within resist compositions designed for use with ArF excimer lasers can be used. Generally, groups that form a cyclic or chain-like tertiary alkyl ester, or a cyclic or chain-like alkoxyalkyl group with the carboxyl group of the (α-lower alkyl) acrylic acid are the most widely known.

Here, a “group that forms a tertiary alkyl ester” describes a group that forms an ester by substituting the hydrogen atom of the acrylic acid carboxyl group. In other words, it represents a group which forms a structure in which the tertiary carbon atom within a chain-like or cyclic tertiary alkyl group is bonded to the oxygen atom at the terminal of the carbonyloxy group [—C(O)—O-] of the acrylate ester. In this tertiary alkyl ester, the action of acid causes cleavage of the bond between the oxygen atom and the tertiary carbon atom.

Here, a “tertiary alkyl group” refers to an alkyl group that includes a tertiary carbon atom.

Examples of groups that form a chain-like tertiary alkyl ester include a tert-butyl group and a tert-pentyl group.

Examples of groups that form a cyclic tertiary alkyl ester include the same types of groups as those exemplified below in the “acid dissociable, dissolution inhibiting group that contains an alicyclic group”.

A “cyclic or chain-like alkoxyalkyl group” forms an ester by substitution with the hydrogen atom of a carboxyl group. In other words, a structure is formed in which the alkoxyalkyl group is bonded to the oxygen atom at the terminal of the carbonyloxy group [—C(O)—O—] of the acrylate ester. In this structure, the action of acid causes cleavage of the bond between the oxygen atom and the alkoxyalkyl group.

Examples of this type of cyclic or chain-like alkoxyalkyl group include a 1-methoxymethyl group, 1-ethoxyethyl group, 1-isopropoxyethyl group, 1-cyclohexyloxyethyl group, 2-adamantoxymethyl group, 1-methyladamantoxymethyl group, 4-oxo-2-adamantoxymethyl group, 1-adamantoxyethyl group, and 2-adamantoxyethyl group.

As the structural unit (a′ 5), structural units including an acid dissociable, dissolution inhibiting group that contains a cyclic group, and particularly an aliphatic cyclic group, are preferred.

Here, the terms “aliphatic” and “aliphatic cyclic group” are as defined above.

The aliphatic cyclic group may be either monocyclic or polycyclic, and can be selected appropriately, for example, from the multitude of groups proposed for use within ArF resists and the like. From the viewpoint of ensuring favorable etching resistance, a polycyclic alicyclic group is preferred. Furthermore the alicyclic group is preferably a hydrocarbon group, and is still more preferably a saturated hydrocarbon group (an alicyclic group).

Examples of suitable monocyclic alicyclic groups include groups in which one hydrogen atom has been removed from a cycloalkane. Examples of suitable polycyclic alicyclic groups include groups in which one hydrogen atom has been removed from a bicycloalkane, tricycloalkane or tetracycloalkane or the like.

Specifically, examples of suitable monocyclic alicyclic groups include a cyclopentyl group or cyclohexyl group. Examples of suitable polycyclic alicyclic groups include groups in which one hydrogen atom has been removed from a polycycloalkane such as adamantane, norbornane, isobornane, tricyclodecane or tetracyclododecane.

Of these groups, an adamantyl group in which one hydrogen atom has been removed from adamantane, a norbornyl group in which one hydrogen atom has been removed from norbornane, a tricyclodecanyl group in which one hydrogen atom has been removed from tricyclodecane, and a tetracyclododecanyl group in which one hydrogen atom has been removed from tetracyclododecane are preferred industrially.

More specifically, the structural unit (a′5) is preferably at least one unit selected from general formulae (I″) to (III″) shown below.

Furthermore, the structural unit (a′5) is preferably a unit derived from an (α-lower alkyl)acrylate ester that has an aforementioned cyclic alkoxyalkyl group at the ester portion, and more specifically, is preferably at least one structural unit selected from amongst units derived from an aliphatic polycyclic alkyloxy lower alkyl (α-lower alkyl) acrylate ester that may contain a substituent group, such as a 2-adamantoxymethyl group, 1-methyladamantoxymethyl group, 4-oxo-2-adamantoxymethyl group, 1-adamantoxyethyl group or 2-adamantoxyethyl group.

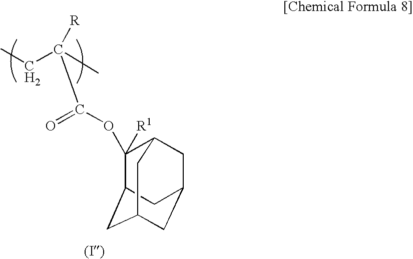

[wherein, R is as defined above, and R¹ represents a lower alkyl group.]

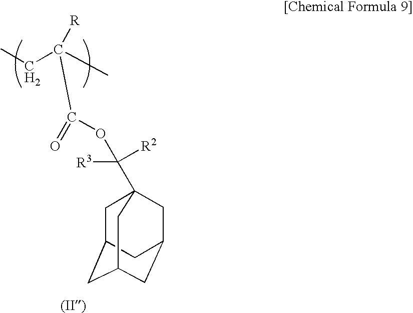

[wherein, R is as defined above, and R² and R³ each independently represents a lower alkyl group.]

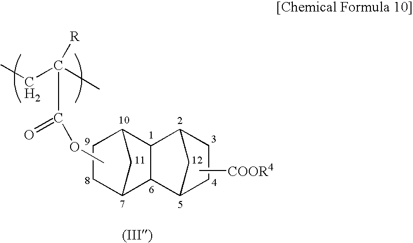

[wherein, R is as defined above, and R⁴ represents a tertiary alkyl group.]

In the general formulae (I″) to (III″), the hydrogen atom or lower alkyl group represented by R is the same as that defined above for R.

The lower alkyl group for R¹ is preferably a linear or branched alkyl group of 1 to 5 carbon atoms, and specific examples include a methyl group, ethyl group, propyl group, isopropyl group, n-butyl group, isobutyl group, pentyl group, isopentyl group or neopentyl group. Of these, a methyl group or ethyl group is preferred from the viewpoint of industrial availability.

It is preferable that the lower alkyl groups of R² and R³ each independently represent a linear or branched alkyl group of 1 to 5 carbon atoms. Of these, those cases in which R² and R³ are both methyl groups are preferred industrially. A structural unit derived from 2-(1-adamantyl)-2-propyl acrylate is a specific example.

Furthermore, R⁴ is a chain-like tertiary alkyl group or a cyclic tertiary alkyl group. Examples of chain-like tertiary alkyl groups include a tert-butyl group or tert-pentyl group, and of these, a tert-butyl group is preferred industrially.

Examples of cyclic tertiary alkyl groups include the same groups as those exemplified above in the “acid dissociable, dissolution inhibiting group that contains an aliphatic cyclic group”, and specific examples include a 2-methyl-2-adamantyl group, 2-ethyl-2-adamantyl group, 2-(1-adamantyl)-2-propyl group, 1-ethylcyclohexyl group, 1-ethylcyclopentyl group, 1-methylcyclohexyl group and 1-methylcyclopentyl group.

Furthermore, the group —COOR⁴ may be bonded to either position 3 or 4 of the tetracyclododecanyl group shown in the formula, although the bonding position cannot be further specified. Furthermore, in a similar manner, the carboxyl group residue of the acrylate structural unit may be bonded to either position 8 or 9 within the formula.

The structural unit (a′5) may use either a single type of structural unit, or a combination of two or more different structural units.

The proportion of the structural unit (a′5) within the component (A′-12), relative to the combined total of all the structural units that constitute the component (A′-12), is preferably within a range from 20 to 60 mol %, more preferably from 30 to 50 mol %, and is most preferably from 35 to 45 mol %. By ensuring that this proportion is at least as large as the lower limit of the above range, a favorable pattern can be obtained, whereas ensuring that the proportion is no greater than the upper limit enables a favorable balance to be achieved with the other structural units.

The component (A′-12) preferably further includes, in addition to the structural unit (a′5) described above, a structural unit (a′6) derived from an acrylate ester that contains a lactone ring. The structural unit (a′6) is effective in improving the adhesion of the resist film to the substrate, and enhancing the hydrophilicity of the resin relative to the developing solution. Furthermore, the coating film formed on top of the pattern exhibits superior adhesion to the pattern.

In the structural unit (a′6), a lower alkyl group or a hydrogen atom is bonded to the α-position carbon atom. The lower allyl group bonded to the α-position carbon atom is the same as that described above for the structural unit (a′5), and is preferably a methyl group.

Examples of the structural unit (a′6) include structural units in which a monocyclic group composed of a lactone ring or a polycyclic cyclic group that includes a lactone ring is bonded to the ester side-chain portion of an acrylate ester.

The term “lactone ring” refers to a single ring containing a —O—C(O)— structure, and this ring is counted as the first ring. Accordingly, in this description, the case in which the only ring structure is the lactone ring is referred to as a monocyclic group, and groups containing other ring structures are described as polycyclic groups regardless of the structure of the other rings.

Examples of the structural unit (a′6) include units having a monocyclic group in which one hydrogen atom has been removed from α-butyrolactone, and units having a polycyclic group in which one hydrogen atom has been removed from a lactone ring-containing bicycloalkane.

Specifically, the structural unit (a′6) is preferably at least one unit selected from general formulas (IV″) through (VII″) shown below.

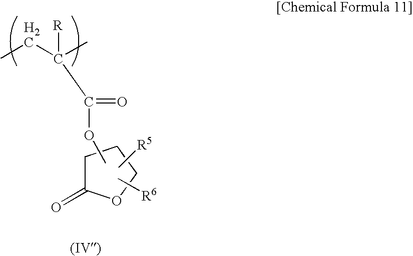

[wherein, R is as defined above, and R⁵ and R⁶ each independently represents a hydrogen atom or a lower alkyl group.]

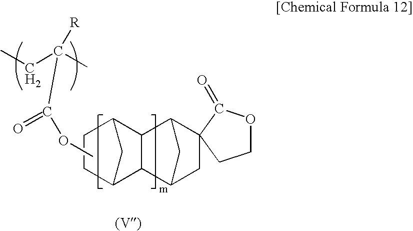

[wherein, R is as defined above, and m represents either 0 or 1.]

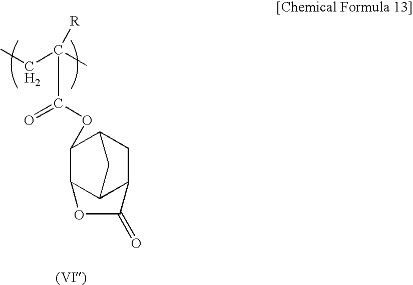

[wherein, R is as defined above.]

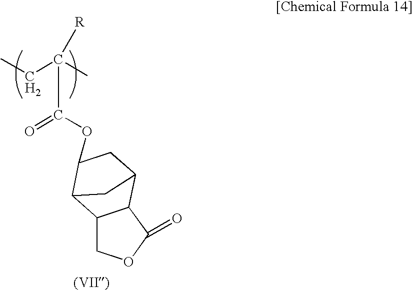

[wherein, R is as defined above.]

In Formula (IV″), R⁵ and R⁶ each independently represents a hydrogen atom or a lower alkyl group, and preferably represents a hydrogen atom. The lower alkyl groups for R⁵ and R⁶ are preferably linear or branched alkyl groups of 1 to 5 carbon atoms, and specific examples include a methyl group, ethyl group, propyl group, isopropyl group, n-butyl group, isobutyl group, tert-butyl group, pentyl group, isopentyl group or neopentyl group. A methyl group is preferred industrially.

Furthermore, amongst the structural units represented by the general formulae (IV″) through (VII″), structural units represented by the general formula (IV″) are low cost and therefore preferred industrially, and of the possible structural units represented by the general formula (IV″), α-methacryloyloxy-γ-butyrolactone, in which R is a methyl group, R⁵ and R⁶ are both hydrogen atoms, and the position of the ester linkage between the methacrylate ester and the γ-butyrolactone is at the α-position on the lactone ring, is the most desirable.

The structural unit (a′6) may use either a single type of structural unit, or a combination of two or more different structural units.

The proportion of the structural unit (a′6) within the component (A′-12), relative to the combined total of all the structural units that constitute the component (A′-12), is preferably within a range from 20 to 60 mol %, more preferably from 20 to 50 mol %, and is most preferably from 30 to 45 mol %. Ensuring that this proportion is at least as large as the lower limit of the above range improves the lithography properties, whereas ensuring that the proportion is no greater than the upper limit enables a favorable balance to be achieved with the other structural units.

The component (A′-12) preferably also includes, either in addition to the structural unit (a′5) described above or in addition to the structural units (a′5) and (a′6), a structural unit (a′7) derived from an acrylate ester that contains a polar group-containing polycyclic group.

Including the structural unit (a′7) increases the hydrophilicity of the entire component (A′-12), thereby improving the affinity with an alkali developing solution, improving the solubility in the alkali developing solution within the exposed portions of the resist, and contributing to an improvement in the resolution. Furthermore, the structural unit (a′7) also enables the formation of a coating film that exhibits superior adhesion to the pattern.

In the structural unit (a′7), a lower alkyl group or a hydrogen atom is bonded to the α-position carbon atom. The lower allyl group bonded to the α-position carbon atom is the same as that described above for the structural unit (a′5), and is preferably a methyl group.

Examples of the polar group include a hydroxyl group, cyano group, carboxyl group or amino group or the like, although a hydroxyl group is particularly preferred.

Examples of the polycyclic group include polycyclic groups selected from amongst the aliphatic cyclic groups exemplified above in the “acid dissociable, dissolution inhibiting group that contains an aliphatic cyclic group” within the aforementioned structural unit (a′5).

The structural unit (a′7) is preferably at least one unit selected from general formulae (VIII″) and (IX″) shown below.

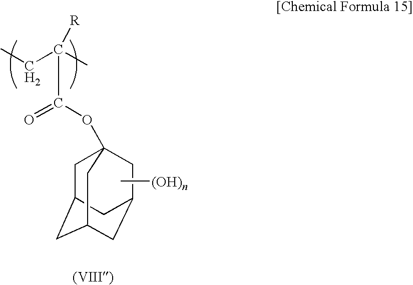

[wherein, R is as defined above, and n represents an integer of 1 to 3.]

In Formula (VIII″), R is as described above for R in the general formulae (I′) to (III′).

Of these units, structural units in which n is 1, and the hydroxyl group is bonded to the 3rd position of the adamantyl group are preferred.

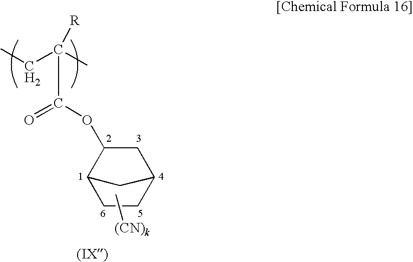

[wherein, R is as defined above, and k represents an integer from 1 to 3.]

Of these units, structural units in which k is 1 are preferred. Furthermore, the cyano group is preferably bonded to the 5th or 6th position of the norbornyl group.

The structural unit (a′7) may use either a single type of structural unit, or a combination of two or more different structural units.

The proportion of the structural unit (a′7) within the component (A′-12), relative to the combined total of all the structural units that constitute the component (A′-12), is preferably within a range from 10 to 50 mol %, more preferably from 15 to 40 mol %, and is most preferably from 20 to 35 mol %. Ensuring that this proportion is at least as large as the lower limit of the above range improves the lithography properties, whereas ensuring that the proportion is no greater than the upper limit enables a favorable balance to be achieved with the other structural units.

In the component (A′-12), the combined total of the structural units (a′5) through (a′7), relative to the combined total of all the structural units, is preferably within a range from 70 to 100 mol %, and is more preferably from 80 to 100 mol %.

The component (A′-12) may also include a structural unit (a′8) besides the aforementioned structural units (a′5) through (a′7).

There are no particular restrictions on the structural unit (a′8), as long as it is a structural unit that cannot be classified as one of the above structural units (a′5) through (a′7).

For example, structural units that contain a polycyclic aliphatic hydrocarbon group and are derived from an (α-lower alkyl)acrylate ester are preferred. Suitable examples of the polycyclic aliphatic hydrocarbon group include polycyclic groups selected appropriately from amongst the aliphatic cyclic groups exemplified above in the “acid dissociable, dissolution inhibiting group that contains an aliphatic cyclic group”. In terms of industrial availability, at least one group selected from amongst a tricyclodecanyl group, adamantyl group, tetracyclododecanyl group, norbornyl group and isobornyl group is particularly preferred. As the structural unit (a′8), a non-acid dissociable group is the most desirable.

Specific examples of the structural unit (a′8) include units of the structures (X″) to (XII″) shown below.

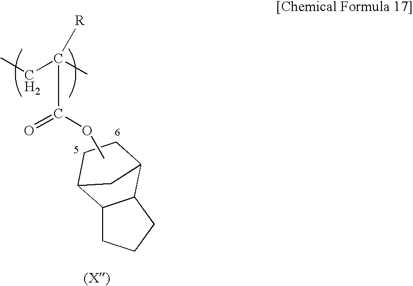

[wherein, R is as defined above.]

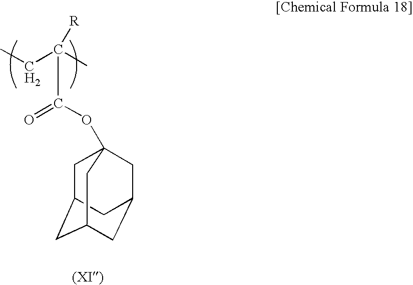

[wherein, R is as defined above.]

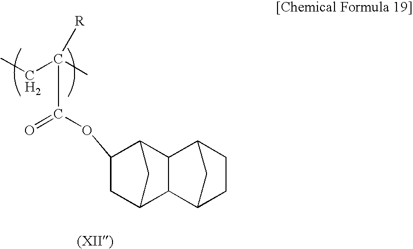

[wherein, R is as defined above.]

In those cases where a structural unit (a′8) is included, the proportion of the structural unit (a′8) within component (A′-12), relative to the combined total of all the structural units that constitute the component (A′-12), is preferably within a range from 1 to 25 mol %, and is more preferably from 5 to 20 mol %.

The component (A′-12) is preferably a copolymer that includes at least the structural units (a′5), (a′6), and (a′7). Examples of such copolymers include copolymers composed solely of the structural units (a′5), (a′6) and (a′7), and copolymers composed of the structural units (a′5), (a′6), (a′7) and (a′8).

The component (A′-1) can be obtained by conducting a polymerization, using a conventional method, of the monomers corresponding with each of the structural units. For example, the component (A′-1) can be obtained by conducting a conventional radical polymerization or the like of the monomers corresponding with each of the structural units, using a radical polymerization initiator such as azobisisobutyronitrile (AIBN).

The weight average molecular weight (the polystyrene equivalent weight average molecular weight determined by gel permeation chromatography, this also applies below) of the component (A′-1) is preferably not more than 30,000, more preferably not more than 20,000, and still more preferably 12,000 or lower. The lower limit for this range is typically 2,000, although from the viewpoints of inhibiting pattern collapse and achieving a favorable improvement in resolution and the like, the weight average molecular weight is preferably at least 4,000, and more preferably 5,000 or greater.

### [Component (A′-2)]

As the component (A′-2), a low-molecular compound containing hydrophilic groups and acid dissociable, dissolution inhibiting groups is preferred. Here, the low-molecular compound in the component (A′-2) is a component which is not a resin component. Specific examples include compounds containing a plurality of phenol structures in which a portion of the hydroxyl group hydrogen atoms have been substituted with acid dissociable, dissolution inhibiting groups.

There are no particular restrictions on the acid dissociable, dissolution inhibiting groups, and examples include the same groups as those exemplified above for the acid dissociable, dissolution inhibiting groups of X and X′.

Preferred examples of the component (A′-2) include low molecular weight phenol compounds in which a portion of the hydrogen atoms of the hydroxyl groups have been substituted with the aforementioned acid dissociable, dissolution inhibiting groups. These types of compounds are known, for example, as sensitizers or heat resistance improvers for use in non-chemically amplified g-line or i-line resists, and any of these compounds may be used.

Specific examples of these low molecular weight phenol compounds include the compounds listed below.

Namely, examples include bis(4-hydroxyphenyl)methane, bis(2,3,4-trihydroxyphenyl)methane, 2-(4-hydroxyphenyl)-2-(4′-hydroxyphenyl)propane, 2-(2,3,4-trihydroxyphenyl)-2-(2′,3′,4′-trihydroxyphenyl)propane, tris(4-hydroxyphenyl)methane, bis(4-hydroxy-3,5-dimethylphenyl)-2-hydroxyphenylmethane, bis(4-hydroxy-2,5-dimethylphenyl)-2-hydroxyphenylmethane, bis(4-hydroxy-3,5-dimethylphenyl)-3,4-dihydroxyphenylmethane, bis(4-hydroxy-2,5-dimethylphenyl)-3,4-dihydroxyphenylmethane, bis(4-hydroxy-3-methylphenyl)-3,4-dihydroxyphenylmethane, bis(3-cyclohexyl-4-hydroxy-6-methylphenyl)-4-hydroxyphenylmethane, bis(3-cyclohexyl-4-hydroxy-6-methylphenyl)-3,4-dihydroxyphenylmethane, 1-[1-(4-hydroxyphenyl)isopropyl]-4-[1,1-bis(4-hydroxyphenyl)ethyl]benzene, and dimers, trimers and tetramers of formalin condensation products of phenols such as phenol, m-cresol, p-cresol and xylenol. Of course, this is not a restrictive list.

### <Component (B′)>

As the component (B′), known materials used as acid generators in conventional chemically amplified resists can be used. Examples of these types of acid generators are numerous, and include onium salt-based acid generators such as iodonium salts and sulfonium salts; oxime sulfonate-based acid generators; diazomethane-based acid generators such as bisalkyl or bisaryl sulfonyl diazomethanes and poly(bis-sulfonyl)diazomethanes; nitrobenzylsulfonate-based acid generators; iminosulfonate-based acid generators; and disulfone-based acid generators.

Specific examples of onium salt-based acid generators include diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, and triphenylsulfonium nonafluorobutanesulfonate. Of these, onium salts with a fluorinated alkylsulfonate ion as the anion are preferred.

Specific examples of oxime sulfonate compounds include α-(methylsulfonyloxyimino)-phenyl acetonitrile, α-(methylsulfonyloxyimino)-p-methoxyphenyl acetonitrile, α-(trifluoromethylsulfonyloxyimino)-phenyl acetonitrile, α-(trifluoromethylsulfonyloxyimino)-p-methoxyphenyl acetonitrile, α-(ethylsulfonyloxyimino)-p-methoxyphenyl acetonitrile, α-(propylsulfonyloxyimino)-p-methylphenyl acetonitrile, and α-(methylsulfonyloxyimino)-p-bromophenyl acetonitrile. Of these, α-(methylsulfonyloxyimino)-p-methoxyphenyl acetonitrile is preferred.

Specific examples of diazomethane-based acid generators include bis(isopropylsulfonyl)diazomethane, bis(p-toluenesulfonyl)diazomethane, bis(1,1-dimethylethylsulfonyl)diazomethane, bis(cyclohexylsulfonyl)diazomethane, and bis(2,4-dimethylphenylsulfonyl)diazomethane.

As the component (B′), either a single acid generator may be used alone, or a combination of two or more different acid generators may be used.

The quantity used of the component (B′) is typically within a range from 1 to 20 parts by weight, and preferably from 2 to 10 parts by weight, per 100 parts by weight of the component (A′). Ensuring that the quantity is at least as large as the lower limit of the above range enables favorable pattern formation, whereas ensuring that the proportion is no greater than the upper limit facilitates the production of a uniform solution, and enables favorable storage stability to be achieved.

### <Optional Components>

In the chemically amplified resist composition, in order to improve properties such as the pattern shape and the post exposure stability of the latent image formed by the pattern-wise exposure of the resist layer, a nitrogen-containing organic compound (D′) (hereafter also referred to as “component (D′)”) may be added as an optional component.

A multitude of these components (D′) have already been proposed, and any of these known compounds may be used, although an amine, and in particular a secondary lower aliphatic amine or tertiary lower aliphatic amine, is preferred.

Here, a “lower aliphatic amine” refers to an alkyl or alkyl alcohol amine of not more than 5 carbon atoms, and specific examples of these secondary and tertiary amines include trimethylamine, diethylamine, triethylamine, di-n-propylamine, tri-n-propylamine, tripentylamine, diethanolamine, triethanolamine and triisopropanolamine, and of these, tertiary alkanolamines such as triethanolamine and triisopropanolamine are particularly preferred.

These compounds may be used either alone, or in combinations of two or more different compounds.

The component (D′) is typically used in a quantity within a range from 0.01 to 5.0 parts by weight per 100 parts by weight of the component (A′).

Furthermore, in the chemically amplified resist composition, in order to prevent any deterioration in sensitivity caused by the addition of the above component (D′) and improve the resist pattern shape and the post exposure stability of the latent image formed by the pattern-wise exposure of the resist layer, an organic carboxylic acid, or a phosphorus oxo acid or derivative thereof (E′) (hereafter also referred to as “component (E′)”) may also be added as another optional component. The component (D′) and the component (E′) can be used in combination, or either one can also be used alone.

As the organic carboxylic acid, compounds such as malonic acid, citric acid, malic acid, succinic acid, benzoic acid and salicylic acid are preferred.

Examples of the phosphorus oxo acid or derivative thereof include phosphoric acid or derivatives thereof such as esters, including phosphoric acid, di-n-butyl phosphate and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred.

The component (E′) is typically used in a quantity within a range from 0.01 to 5.0 parts by weight per 100 parts by weight of the component (A′).

If desired, other miscible additives can also be added to the chemically amplified resist composition. Examples of such miscible additives include additive resins for improving the performance of the applied film of the resist composition, surfactants for improving the coating properties, dissolution inhibitors, plasticizers, stabilizers, colorants and halation prevention agents.

The chemically amplified resist composition can be prepared by dissolving the materials for the resist composition in an organic solvent (S′) (hereafter, also referred to as “component (S′)”).

The component (S′) may be any organic solvent capable of dissolving the respective components to generate a uniform solution, and one or more types of organic solvent can be appropriately selected from those solvents that have conventionally been known as solvents for resist compositions.

Specific examples of the solvent include lactones such as γ-butyrolactone; ketones such as acetone, methyl ethyl ketone, cyclohexanone, methyl isopentyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, propylene glycol monomethyl ether acetate (PGMEA), dipropylene glycol, and the monomethyl ether, monoethyl ether, monopropyl ether, monobutyl ether or monophenyl ether of dipropylene glycol monoacetate; cyclic ethers such as dioxane; and esters such as methyl lactate, ethyl lactate (EL), methyl acetate, ethyl acetate, butyl acetate, methyl pyruvate, ethyl pyruvate, methyl methoxypropionate, and ethyl ethoxypropionate. Of these, PGMEA, EL, and propylene glycol monomethyl ether (PGME) are preferred. These organic solvents may be used either alone, or as a mixed solvent of two or more different solvents.

There are no particular restrictions on the quantity used of the component (S′), and a quantity that results in a chemically amplified resist composition in liquid form that has a concentration suitable for application to a substrate is used.

In the present invention, a radiation-sensitive composition other than the chemically amplified resist composition described above may be used. An example of such a radiation-sensitive composition is a resist composition that includes an alkali-soluble resin such as a novolak resin or a hydroxystyrene resin, and a photosensitive component such as a naphthoquinonediazide group-containing compound. If necessary, a sensitizer may also be included within this resist composition.

### [Method of Forming Template Using Lithography Process]

In those cases where an aforementioned template-forming material is used, a lithography process is preferably used for forming the template, as it enables the formation of a microscopic pattern with a high degree of precision.

Formation of the template using a lithography process can be conducted using a conventional procedure, and for example in those cases where a chemically amplified resist composition is used, can be conducted in the manner described below.

First, the resist composition is applied onto a substrate using a spinner or the like, and a prebake (Post Applied Bake (PAB)) is conducted under temperature conditions of 80 to 150° C. for 40 to 120 seconds, and preferably for 60 to 90 seconds, to form a resist film. Although there are no particular restrictions on the thickness of the resist film, the thickness is typically fixed within a range from several tens of nm to several μm, and is preferably from 100 to 800 nm.

Subsequently, following selective exposure of the resist film using a commercially available exposure apparatus or the like, PEB (Post Exposure Baking) is conducted under temperature conditions of 80 to 150° C. for 40 to 120 seconds, and preferably for 60 to 90 seconds. Subsequently, a developing treatment is conducted using an alkali developing solution such as a 0.1 to 10% by weight aqueous solution of tetramethylammonium hydroxide. In this manner, a template (resist pattern) can be formed.

There are no particular restrictions on the exposure radiation source, which may be selected appropriately in accordance with the resist composition that is used. Specifically, the exposure radiation source varies depending on factors such as the light absorbance of the metal oxide nanomaterial-forming composition that is applied, the film thickness of the metal oxide nanomaterial-forming composition and the size of the template structure that is drawn by the exposure, and thus the exposure radiation source cannot necessarily be limited. Generally, radiation within a range from far ultraviolet radiation of 300 nm or less through to extreme ultraviolet radiation of several nm, or radiation in the X-ray region can be used. For example, KrF, ArF, electron beams, EUV (Extreme Ultraviolet, wavelength: approximately 13.5 nm) and X-rays and the like can be used. In those cases where a chemically amplified resist composition described above is used, an ArF excimer laser, KrF excimer laser, F₂ excimer laser, EUV (extreme ultraviolet), VUV (vacuum ultraviolet), electron beam, X-ray or soft X-ray is preferred. On the other hand, when a radiation-sensitive composition other than the aforementioned chemically amplified composition is used, the use of an electron beam enables the formation of a very fine pattern of not more than 200 nm, and is consequently preferred.

The treatment conditions for forming a template via a lithography process are not restricted to the conditions described above, and may be determined appropriately in accordance with the composition of the template-forming material.

Further, the method of forming the template is not restricted to lithography processes. For example, an imprint process (a process that uses a microscopic structure prepared by pressing a substrate that has been microfabricated in advance against another substrate, thereby transferring the microfabricated structure) can be used. The imprint process can be used regardless of whether or not the template-forming material exhibits radiation sensitivity.

### [Hydrophilic Treatment]

In the present invention, prior to formation of a metal layer on the template surface by electroless plating in the following step, the surface of the template is preferably subjected to a hydrophilic treatment. By conducting a hydrophilic treatment, the hydrophilicity of the template surface increases (activation), meaning electroless plating can be used to form the metal layer on the template surface with high density and superior adhesion. Further, in the subsequent coating film formation step, an electroless plating catalyst can be readily introduced onto the template surface. As a result, the coating film can be formed with a shape that represents a highly precise reproduction or transferal of the template shape.

Conventional methods can be used for conducting the hydrophilic treatment, and examples include oxygen plasma treatments, ozone oxidation treatments, acid-alkali treatments and chemical modification treatments. Of these, an oxygen plasma treatment is preferred, as the treatment time is short and the treatment is relatively simple. Furthermore, by conducting an oxygen plasma treatment, not only can the template surface be activated, but the height of the template, and therefore the height of the structure that is formed can also be controlled by controlling the treatment conditions. For example, the longer the oxygen plasma treatment time, the lower the template height becomes, resulting in a more microscopic structure.

When an oxygen plasma treatment is used, the pressure during the oxygen plasma treatment is preferably within a range from 1.33 to 66.5 Pa (10 to 500 mtorr), and more preferably from 13.3 to 26.6 Pa (100 to 200 mtorr). Further, the plasma output during the oxygen plasma treatment is preferably within a range from 5 to 500 W, and more preferably from 5 to 50 W. Furthermore, the treatment time for the oxygen plasma treatment is preferably within a range from 1 to 30 seconds, and more preferably from 2 to 5 seconds. The temperature during the oxygen plasma treatment is preferably within a range from −30 to 300° C., more preferably from 0 to 100° C., and is most preferably set to room temperature (5 to 40° C.). There are no particular restrictions on the apparatus used for the oxygen plasma treatment, and for example, an apparatus such as a PE-2000 Plasma Etcher manufactured by South Bay Technology, USA can be used.

### <Coating Film Formation Step>

In this step, a coating film that includes a metal layer formed by electroless plating is formed on the surface of the template described above.

### [Metal Layer]

Electroless plating is conducted by bringing a plating solution containing ions of a predetermined metal into contact with the template surface, and then reducing those ions (thereby depositing a metal). This process enables the formation of a metal layer composed of the predetermined metal.

In those cases where the target metal is a metal for which direct electroless plating is difficult (for example, noble metals such as gold), a metal layer of the target metal can be formed comparatively easily by first using electroless plating to form a metal layer of a metal (such as nickel) that has a higher ionization tendency than the target metal, and subsequently substituting the metal of this metal layer with the target metal.

There are no particular restrictions on the metal used for electroless plating, and any of the metals typically used for electroless plating can be used. Specific examples include gold, silver, copper, nickel, cobalt, tin, and platinum-group metals (palladium, platinum, rhodium and ruthenium). Of these, at least one metal selected from the group consisting of gold, silver, copper, nickel and cobalt is preferred, as the plating technology for these metals is generally well established.

In the present invention, because a metal layer that exhibits conductivity is preferred, the metal that constitutes the metal layer is preferably at least one metal selected from the group consisting of gold, silver and copper. In other words, the metal layer preferably includes either one, or two or more of a gold layer, a silver layer and a copper layer. Of these, the metal that constitutes the metal layer is more preferably gold or silver.

Further, cobalt is also preferred as the metal that constitutes the metal layer, as it yields a structure that exhibits powerful magnetism.

The reduction of the metal ions can be conducted using conventional methods. Specific examples include methods that use a reduction reaction catalyst (an clectroless plating catalyst), and methods that involve substitution of a metal having a higher ionization tendency than the target metal.

In the present invention, the electroless plating is preferably conducted after introduction of the electroless plating catalyst at the template surface. This catalyst acts as a nucleus for the electroless plating, promoting the reduction reaction of the metal ions that contact the template surface, and therefore enables the efficient formation of a metal layer with a high degree of plating selectivity at the template surface.

As the electroless plating catalyst, fine particles or a thin film of a metal is typically used.

The type of metal used for the catalyst varies depending on the nature of the target metal being used, but is typically either the same as the target metal, or a metal that ionizes more readily than the target metal.

Specifically, in those cases where the target metal is silver, a silver catalyst is normally used, in those cases where the target metal is copper, a silver catalyst or copper catalyst is normally used, and in those cases where the target metal is nickel, cobalt or gold or the like, a palladium catalyst or tin catalyst or the like is normally used. A single catalyst may be used alone, or a combination of two or more catalysts may be used.

Introduction of the catalyst at the template surface can be conducted using conventional methods. For example, an aqueous solution of a salt of the metal that is to act as the catalyst (for example, silver nitrate or a metal chloride or the like) may be brought into contact with the template surface, and the salt subsequently adsorbed to the template surface and then reduced. This enables the introduction of metal microparticles on the template surface.

The metal layer incorporated within the coating film may be of a single type, or may include two or more different types of metal layer. For example, the metal layer may be a composite layer formed by laminating two or more metal layers of different metals (for example, a silver-copper composite layer composed of a silver layer and a copper layer), or may have a structure in which two or more metal layers are laminated together with another layer (such as a metal oxide layer or organic/metal oxide composite layer described below) disposed therebetween.

The thickness of the metal layer may be set appropriately in accordance with the dimensions of the structure being formed.

In the present invention, the thickness of the entire coating film is preferably not more than 150 nm, more preferably not more than 120 nm, still more preferably not more than 100 nm, and is most preferably 80 nm or less.

There are no particular restrictions on the lower limit for this thickness value, although considering factors such as the structural strength and the film uniformity of the electroless plating, the thickness is preferably at least 1 nm, more preferably 10 nm or greater, and still more preferably 30 nm or greater.

The thickness of the metal layer can be set to the desired value by appropriate alteration of the treatment time for the electroless plating. For example, a longer treatment time for the electroless plating results in a thicker metal layer, enabling the thickness of the coating film to be increased.

### [Other Layers]

The coating film may be composed solely of the above metal layer, or may also include one or more other layers besides the metal layer.

There are no particular restrictions on this other layer besides the metal layer, provided the resulting structure does not depart from the purpose of the present invention, and one or more layers selected from the group consisting of metal oxide layers, organic/metal oxide composite layers, organic compound layers and organic/inorganic composite layers may be used. A metal oxide layer or organic/metal oxide composite layer is preferred. The above other layer included within the coating film may be of a single type, or may include two or more different types of layer.

Of the above possibilities, a layer that includes an oxide of a metal such as silicon (metallic silicon), titanium, zirconium or hafnium is preferred. A thin film formed from silica is particularly preferred, as it is ideal for all manner of thin films, including etching-resistant materials or insulating films or the like used in the production of semiconductor elements or liquid crystal elements.

These other layers can be formed using conventional thin film formation methods such as surface sol-gel methods, layer-by layer adsorption methods, spin coating methods, dip coating methods, the LB method (Langmuir-Blodgett methods) and CVD methods (chemical vapor deposition methods).

Further, examples of materials that can be used favorably for forming these other layers include the amorphous metal oxide thin-film materials disclosed in Japanese Unexamined Patent Application, First Publication No. 2002-338211, which have a structure prepared by dispersing an organic component at the molecular level within an organic/metal oxide composite thin film and subsequently removing the portions corresponding with organic component; and the thin-film materials disclosed in International Patent Application, No. WO03/095193, composed of a thin-film layer of a polymer having hydroxyl groups or carboxyl groups on the surface, and a metal oxide thin-film layer or organic/metal oxide composite thin-film layer that undergoes coordination bonding or covalent bonding to the polymer thin-film layer via the hydroxyl groups or carboxyl groups. Furthermore, the metal oxide thin films and organic compound thin films disclosed in Japanese Unexamined Patent Application, First Publication No. Hei 10-249985, Japanese Unexamined Patent Application, First Publication No. 2005-205584 and Japanese Unexamined Patent Application, First Publication No. 2006-297575, or composites of these films may also be favorably employed.

As the organic material used in the thin film, a polymer that bears a charge, namely a polyanion and/or polycation, is preferred, wherein a polyanion is a polymer having functional groups that are capable of adopting a negative charge such as polyglutamic acid, sulfonic acid, sulfuric acid or carboxylic acid groups, and specific examples of preferred polyanions include polystyrenesulfonic acid (PSS), polyvinylsulfuric acid (PVS), dextran sulfuric acid, chondroitin sulfuric acid, polyacrylic acid (PAA), polymethacrylic acid (PMA), polymaleic acid, and polyfumaric acid. Of these, polystyrenesulfonic acid (PSS) and polymaleic acid are particularly desirable. On the other hand, a polycation is a polymer having functional groups that are capable of adopting a positive charge such as quaternary ammonium groups or amino groups, and specific examples of preferred polycations include polyethyleneimine (PEI), polyallylamine hydrochloride (PAH), polydiallyldimethylammonium chloride (PDDA), polyvinylpyridine (PVP) and polylysine. Of these, polyallylamine hydrochloride (PAH) and polydiallyldimethylammonium chloride (PDDA) are particularly desirable.

However, the present invention is not restricted to the above polyanions and/or polycations, and polymer compounds containing hydroxyl groups or carboxyl groups such as polyacrylic acid, polyvinyl alcohol and polypyrrole; polysaccharides such as starch, glycogen, alginic acid, carrageenan and agarose; polyimides; phenolic resins; methyl polymethacrylate; polyamides of acrylamide or the like; polyvinyl compounds of vinyl chloride or the like; styrene-based polymers such as polystyrene; polythiophene; polyphenylenevinylene; polyacetylene; and derivatives or copolymers of these polymers may also be widely used.

Furthermore, organic low-molecular compounds may also be widely used, provided they are capable of coating the template surface, and examples of preferred compounds include surfactant molecules having long-chain alkyl groups, long-chain thiols, and halides. Moreover, molecules having a plurality of functional groups that exhibit molecular recognition such as aminotriazines, cyclic imides (such as cyanuric acid, barbituric acid, thiobarbituric acid and thymine), guanidinium groups, carboxyl groups or phosphoric acid groups, which are able to form network structures, can also be used.

In addition, conductive polymers, functional polymers such as poly(aniline-N-propanesulfonic acid) (PAN), various deoxyribonucleic acids (DNA) or ribonucleic acids (RNA), proteins, oligopeptides, polysaccharides that bear a charge such as pectin, and biopolymers that bear a charge may also be used.

Moreover, in order to enhance the mechanical strength of the organic thin film, cross-linking treatments using a cross-linker, or thin-film strengthening operations using heat, electricity or chemical treatments may also be used as appropriate.

When the other film described above is formed using a surface sol-gel method, the layer can be formed, for example, in accordance with the method disclosed in Japanese Unexamined Patent Application, First Publication No. 2002-338211, by repeatedly immersing the surface of a template having surface functional groups capable of reacting with a metal compound having an alkoxy group (hereinafter, also referred to as a “metal alkoxide”) within an aqueous solution of a metal alkoxide. The metal oxide thin film is formed from the solution by the stepwise adsorption of the metal alkoxide to the template surface. The thickness of a metal oxide thin film produced using this method can be precisely controlled at the nanometer level. Furthermore, a metal oxide ultra thin film uses thin film formation based on polycondensation of a metal alkoxide, and the precision of the resulting template coating can be controlled up to the molecular level. Accordingly, the shape of a template structure having a nanometer level shape can be accurately reproduced.

Further, a metal oxide film can also be formed by the above technique, by using a metal compound other than the metal alkoxides described above, which is capable of generating hydroxyl groups upon hydrolysis. As this type of metal compound, metal compounds having an isocyanate group, metal compounds having a halogen atom, and metal compounds having a carbonyl group may be exemplified.

Examples of these metal alkoxides include metal alkoxide compounds of metals other than rare earth metals, such as titanium butoxide (Ti(O-nBu)₄), zirconium propoxide (Zr(O-nPr)₄), aluminum butoxide (Al(O-nBu)₃), niobium butoxide (Nb(O-nBu)₅), silicon tetramethoxide (Si(O-Me)₄), and boron ethoxide (B(O-Et)₃); metal alkoxide compounds of rare earth metals, such as lanthanide isopropoxide (Ln(O-iPr)₃) and yttrium isopropoxide (Y(O-iPr)₃); double alkoxide compounds such as barium titanium alkoxide (BaTi(OR⁶⁰)_{X3}) (wherein, R⁶⁰ represents a lower alkyl group of 1 to 5 carbon atoms, and X₃ represents an integer of 2 to 4); metal alkoxide compounds containing two or more alkoxy groups and an organic group other than an alkoxy group, such as methyltrimethoxysilane (MeSi(O-Me)₃) and diethyldiethoxysilane (Et₂Si(O-Et)₂); and metal alkoxide compounds containing a ligand such as acetylacetone, and two or more alkoxy groups.

Furthermore, microparticles of alkoxide sols or alkoxide gels obtained by adding a small quantity of water to one of the above metal alkoxides to be hydrolyzed and condensed partially can also be used.

Moreover, binuclear or cluster-type alkoxide compounds containing a plurality of metal atoms or a plurality of different metal elements, such as titanium butoxide tetramer (C₄H₉O[Ti(OC₄H₉)₂O]₄C₄H₉), and polymers based on metal alkoxide compounds that have undergone one-dimensional cross-linking via oxygen atoms, are also included within the above metal alkoxides.

Examples of metal compounds containing an isocyanate group include compounds containing two or more isocyanate groups, as represented by the general formula M(NCO)_{X0} (wherein, M represents a metal atom, and X₀ represents an integer of 2 to 4). Specific examples include tetraisocyanatesilane (Si(NCO)₄), titanium tetraisocyanate (Ti(NCO)₄), zirconium tetraisocyanate (Zr(NCO)₄), and aluminum triisocyanate (Al(NCO)₃).

Examples of metal compounds containing a halogen atom include halogenated metal compounds containing two or more (and preferably from 2 to 4) halogen atoms, as represented by the general formula M(X₁)_{n″} (wherein, M represents a metal atom, X₁ represents one type of atom selected from amongst a fluorine atom, chlorine atom, bromine atom and iodine atom, and n″ represents an integer from 2 to 4). The compound containing a halogen atom may also be a metal complex. Specific examples include tetrachlorotitanium (TiCl₄) and tetrachlorosilane (SiCl₄). Also, examples of the metal complex include cobalt chloride (CoCl₂).

Examples of metal compounds containing a carbonyl group include metal carbonyl compounds such as titanium oxoacetylacetate (TiO(OCOCH₂COCH₃)₂) and pentacarbonyl iron (Fe(CO)₅), as well as polynuclear clusters of these compounds.

Amongst the above compounds, silicon compounds containing two or more (and preferably from 2 to 4) isocyanate groups and/or halogen atoms are particularly preferred, as they exhibit a high level of activity, and can readily form a metal oxide film with superior etching resistance even without conducting a heat treatment.

The number of silicon atoms within each molecule of the silicon compound may be either one, or two or more, although one atom is preferred. Of these compounds, compounds represented by a general formula (w-1) shown below are preferred.

SiWₐ (w-1)

In the formula (w-1), a represents an integer of 2 to 4, and is most preferably 4.

W represents an isocyanate group (an NCO group) or a halogen atom, and the plurality of W groups may be either the same or mutually different.

Examples of the halogen atom for W include the same as the halogen atoms listed above in the metal compound having a halogen atom, and a chlorine atom is preferred. Of these, an isocyanate group is particularly preferred.

### <Template Removal Step>

In this step, a portion or all of the template is removed while retaining a portion or all of the coating film. At this point, at least a part of the coating film remains on top of the substrate, and this residual coating film constitutes a portion or all of the structure.

The method used for removing the template can employ a wide range of conventional template removal methods. From the viewpoint of controllability, the template is preferably removed by conducting at least one treatment selected from the group consisting of plasma treatments, ozone oxidation treatments, elution and firing. Of these, a plasma treatment is particularly desirable.

In cases where a plasma treatment is conducted, the treatment method and treatment conditions may be set in accordance with the composition of the template that is to be removed.

For example, the treatment time, pressure, plasma output and temperature during the plasma treatment may be set in accordance with factors such as the nature and size of the components that are to be removed, and the plasma source.

As the plasma source for the plasma treatment, a variety of gases such as oxygen gas, hydrogen gas or nitrogen gas can be used. Of these, an oxygen plasma treatment that uses oxygen gas or a hydrogen plasma treatment that uses hydrogen gas is preferred, and a hydrogen plasma treatment is particularly desirable as it enables the prevention of oxidation of the generated metal structure.

When an oxygen plasma treatment is used, the pressure during the oxygen plasma treatment is preferably within a range from 1.33 to 66.5 Pa (10 to 500 mtorr), and more preferably from 13.3 to 26.6 Pa (100 to 200 mtorr). Further, the plasma output during the oxygen plasma treatment is preferably within a range from 5 to 500 W, and more preferably from 10 to 50 W. Furthermore, the treatment time for the oxygen plasma treatment is preferably within a range from 5 minutes to several hours, and more preferably from 5 to 60 minutes. The temperature during the oxygen plasma treatment is typically a low temperature, and is preferably within a range from −30 to 300° C., more preferably from 0 to 100° C., and is most preferably set to room temperature (5 to 40° C.). There are no particular restrictions on the apparatus used for the oxygen plasma treatment, and for example, an apparatus such as a PE-2000 Plasma Etcher manufactured by South Bay Technology, USA can be used.

When a hydrogen plasma treatment is used, the pressure during the hydrogen plasma treatment is preferably within a range from 1.33 to 66.5 Pa (10 to 500 mtorr), and more preferably from 13.3 to 26.6 Pa (100 to 200 mtorr). Further, the plasma output during the hydrogen plasma treatment is preferably within a range from 5 to 500 W, and more preferably from 10 to 50 W. Furthermore, the treatment time for the hydrogen plasma treatment is preferably within a range from 5 minutes to several hours, and more preferably from 5 to 60 minutes. The temperature during the hydrogen plasma treatment is typically a low temperature, and is preferably within a range from −30 to 300° C., more preferably from 0 to 100° C., and is most preferably set to room temperature (5 to 40° C.). There are no particular restrictions on the apparatus used for the hydrogen plasma treatment, and for example, an apparatus such as a PE-2000 Plasma Etcher manufactured by South Bay Technology, USA can be used.

When an ozone oxidation treatment is used, the conditions may be set in accordance with the composition of the template that is to be removed and the variety of apparatus used for the treatment. For example, the pressure during the ozone oxidation treatment is preferably within a range from atmospheric pressure to 13.3 Pa (100 mtorr), and more preferably from 133.3 to 13,333.3 Pa (0.1 to 100 torr). Further, the treatment time for the ozone oxidation treatment is preferably within a range from several minutes to several hours, and more preferably from 5 to 60 minutes. The treatment temperature is typically within a range from room temperature to 600° C., and more preferably from room temperature to 400° C.

When an elution treatment is used, a conventional elution method may be employed that is appropriate for the components of the template that is to be removed. For example, in those cases where the template has been formed using a template-forming material containing an aforementioned organic compound with a molecular weight of at least 500, the template can be eluted using an organic solvent such as methanol, ethanol, acetone, or the like.

When a firing treatment is used, the treatment is preferably conducted in air at a temperature within a range from 100 to 1,000° C., and more preferably from 300 to 500° C., for a period of 30 seconds to several hours, and more preferably from 1 to 60 minutes. Further, in those cases where a substrate of a readily oxidizable material such as silicon is used, the firing treatment is preferably conducted in a nitrogen atmosphere in order to prevent oxidation of the substrate. The conditions for a firing treatment conducted in nitrogen atmosphere are the same as those for a treatment conducted in air.

At this point, the template may be completely removed, or a portion may be removed. If a portion of the template is removed, then 1 to 99% of the entire template is preferably removed, and the removal of 5 to 95% is more preferable. When a portion of the template is removed in this manner, the resulting structure is obtained as a coating film-template composite a part of which includes the template. This composite structure may be used in this state, without further modification, or may be subjected to further processing.

Furthermore, in those cases where a plurality of templates are provided, the steps for removing the templates may be conducted simultaneously, or may be conducted separately. If conducted separately, then the templates are preferably removed in sequence, starting at the innermost or lowest template.

Moreover, in those cases where a plurality of templates are provided, all of the templates need not necessarily be removed, and each template may be either removed entirely, or removed partially. If a portion of a template is removed, then 1 to 99% of the entire template is preferably removed, and the removal of 5 to 95% is more preferable. When a portion of the template is removed in this manner, the resulting structure is obtained as a coating film-template composite a part of which includes the template, and the nanostructure may be used in this state, without further modification.

In those cases where besides the above metal oxide layer, the coating film also includes, as another layer, a layer containing an organic compound (for example, the organic/metal oxide composite layer described above), a portion or all of the organic compound within the layer containing the organic compound may be removed during the template removal step, at the same time as the removal of the template.

If a portion or all of the organic compound is removed, then a structure is formed in which those portions corresponding with the organic compound have been removed. In other words, a structure is formed that includes voids that correspond with the molecular shape of the removed organic compound.

Specific examples include: a) structures in which the portions corresponding with the organic compound contained within the organic/metal oxide composite layer are converted directly to voids; b) structures in which voids are formed that are centered around the portions corresponding with the organic compound contained within the organic/metal oxide composite layer but which also include neighboring regions; and c) structures in which the portions corresponding with the organic compound contained within the organic/metal oxide composite layer or the neighboring regions become voids, and portions of these voids are interconnected, generating a network-type void structure.

Structures having these types of voids can be used, for example, as molecular structure-selective permeation films.

If necessary, a step of removing the organic compound within the organic/metal oxide composite layer may be provided separately from the template removal step. For example, a step that involves conducting a plasma, ozone oxidation, elution or firing treatment may be performed under different treatment conditions from those used in the template removal step.

### <Step of Removing a Portion of the Coating Film>

In the present invention, prior to the above template removal step, a step of removing a portion of the coating film may be performed.

In such a case, the removal of the coating film is preferably conducted so as to expose a portion of the template. This enables removal of the template to be conducted easily by etching or the like.

Further, a portion of the coating film may also be removed following the template removal step, and a method in which a portion of the coating film is removed following removal of a portion of the template during the template removal step is preferred.

In the present invention, in those cases where a portion of the coating film is removed following removal of a portion of the template, the removal of the coating film is preferably conducted so as to expose a portion of the template. This enables removal of the template to be conducted easily by etching or the like.

As the method of removing a portion of the coating film, any method capable of processing the metal layer may be used, and a known method may be employed, with due consideration of the nature of the material that constitutes the coating film, and if necessary the composition of the template. Examples of conventional methods include etching, chemical treatments, physical removal, and polishing methods. Of these methods, etching is preferred, as it is simple and requires minimal steps. Dry etching using argon, oxygen, or the like is particularly preferred.

There are no particular restrictions on the size of the portion of the coating film that is removed, and the portion removed preferably is within a range of 1 to 99%, and more preferably 5 to 95% of the entire film.

In the step of removing of a portion of the coating film, although there are no particular restrictions on the portions that are removed, removal of a single plane that includes a portion of the coating film is preferred. In such a case, this single plane may be parallel to the substrate surface, perpendicular to the substrate surface, or at a suitable angle of inclination relative to the substrate surface. Needless to say, other removal processes may also be used.

In this step, removal of the top portion of the coating film is particularly preferred. Of the various possibilities, in those cases where a template with a rectangular cross-sectional shape is employed, for example, a rectangular line structure, hole structure or cylindrical columnar structure, removal of the top portion, including the uppermost surface, of the coating film provided on the template surface is particularly preferred.

In a specific example, in a case where a hole structure is used as the template, when a coating film is formed on the surface of this template, the top portion of the coating film is removed, and the template is then removed, then only the side wall portions of the coating film remain on the substrate surface. As a result, a cylindrical structure with an outer diameter equal to the inner diameter of the hole is obtained.

Further, in a case where a rectangular line structure is used as the template, when a coating film is formed on the surface of this template, the top portion of the coating film is removed, and the template is then removed, then only the side wall portions of the coating film remain on the substrate surface. As a result, line-shaped structures (in which the width is equivalent to the thickness of the coating film, and the height is equal to the height of the remaining side wall portion) are formed on top of the substrate.

Furthermore, during removal of the top portion, by controlling the size of the portion removed, the height of the formed structure can be altered. Namely, the larger the portion removed from the top of the coating film, the lower the formed structure will become, resulting in a more microscopic structure.

In this manner, by removing the top portion of the coating film and utilizing the side wall portions of the coating film, a nanolevel structure can be formed with ease, even if the size of template used is not particularly small.

In the present invention, the removal of a portion of the coating film, and the removal of a portion or all of the template may be conducted either consecutively or simultaneously. For example, in the case where a template in which the longitudinal section is rectangular is used as a template with a rectangular cross-section, a single etching treatment can be used for removal of the uppermost portion of the coating film, followed by removal of the top portions of the coating film side walls, and a portion or all of the template disposed inside those walls.

In this manner, a nanostructure composed of a portion or all of the coating film, or a nanostructure composed of a portion or all of the coating film and a portion of the template is formed on the substrate.

### <Production of a Resin Film Having a Nanostructure Therein>

Next, a resin film is produced that contains the nanostructure formed on a substrate in the manner described above embedded inside the resin film. In terms of simplicity and minimizing the risk of damage to the nanostructure, the method used for producing the resin film preferably involves applying a resin solution to the substrate having the nanostructure formed thereon, thereby forming a resin film, and then detaching the resin film from the substrate, thereby producing a resin film having the nanostructure embedded therein.

There are no particular restrictions on the resin used in the above resin solution, and any resin typically used in the formation of films may be used. Examples of such resins include polyvinyl alcohol, polyacrylic acid, polystyrene, COC resin (a resin manufactured by Cybax, Inc.), PMMA (an acrylic resin), polyethylene, polypropylene, and polyethylene terephthalate. As the resin, a water-soluble resin is preferred as it offers superior levels of safety and ease of operation.

Examples of water-soluble resins include polyelectrolytes such as polyvinyl alcohol and polyacrylic acid, and polysaccharide-based polymers such as agarose, as well as mixtures of these resins.

Furthermore, by using a highly transparent resin such as polyvinyl alcohol or PMMA, the film can be imparted with favorable transparency.

In addition, by using a polystyrene or COC resin, the film can be detached from the film substrate with excellent reproducibility during the film production process.

Specifically, the resin film can be produced in the manner described below.

First, the resin solution is applied onto the nanostructure formed on the substrate, thereby forming a resin film.

There are no particular restrictions on the application method, which may be conducted in accordance with known methods used for forming resist films and the like. Specific examples include methods in which a spinner or the like is used to apply the above resin solution to the nanostructure, and methods in which the substrate bearing the nanostructure is dipped in the resin solution.

The thickness of the resin film is preferably either similar to the height of the nanostructure, or a height that covers the top portion of the nanostructure.

Subsequently, the resin film with the nanostructure embedded therein is detached from the substrate. There are no particular restrictions on the method used for this detachment, provided the nanostructure is supported. For example, tweezers or the like may be used to conduct the detachment, or the structure may be dipped in liquid nitrogen and the film then peeled away from the substrate.

Besides the method described above, a method may also be used in which the substrate is pressed against a preformed resin film, thereby embedding the nanostructure on the substrate surface within the interior of the resin film.

A preferred embodiment of the production method (1) of the present invention is described below with reference to the drawings, although needless to say, this embodiment in no way precludes other embodiments.

### FIRST EMBODIMENT

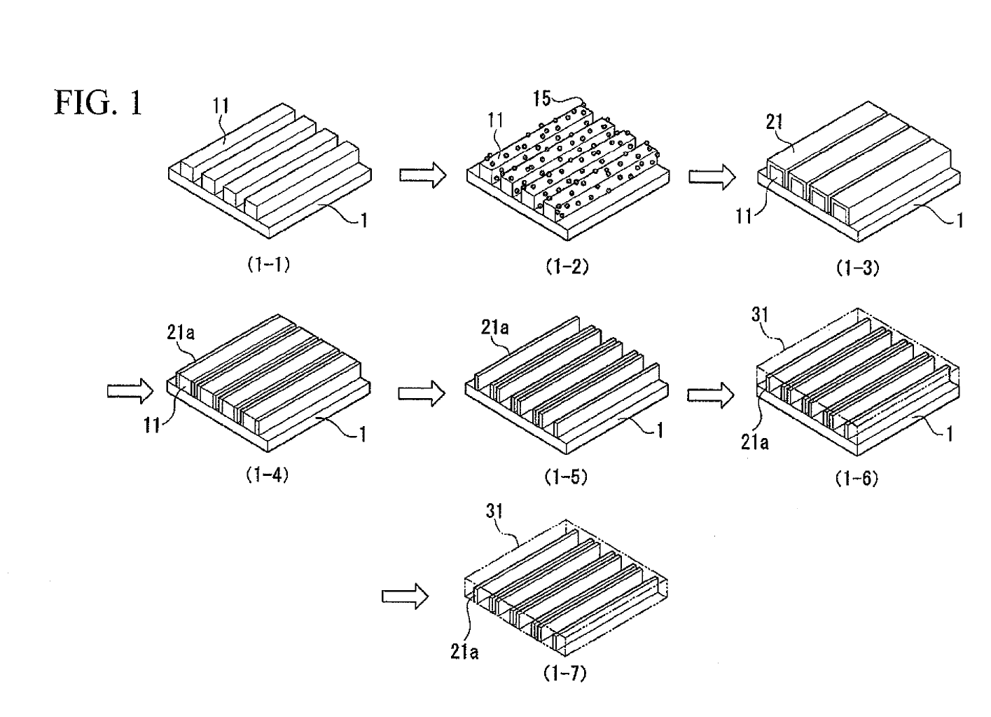

FIG. 1 shows a flowchart for a first embodiment.

In this embodiment, first, a template 11 composed of a rectangular line structure is formed on a substrate 1 (1-1).

Next, a catalyst (fine metal particles) 15 is introduced onto the surface of the template 11 (1-2). Electroless plating is then performed on the surface of the template 11, thereby forming a coating film 21 composed of a metal layer (1-3). Next, the top portion of the coating film 21 is removed along a plane parallel to the substrate 1, thereby exposing the template 11 (1-4). At this point, a portion of the template 11 may also be removed together with the top portion of the coating film 21. Finally, the template 11 is removed. As a result, only the side wall portions 21a of the coating film 21 remain on the substrate 1 (1-5).

Subsequently, a resin film 31 is formed on the substrate 1 having the side wall portions 21a formed thereon (1-6). This resin film 31 is then detached from the substrate 1 with the side wall portions 21a retained inside the resin film (1-7).

As a result, a resin film is obtained that contains line-shaped nanostructures of rectangular cross-section embedded within the film.

On the other hand, following the formation of the coating film 21 (1-3), if the resin film 31 is formed without removing the top portion of the coating film 21, then a resin film can be obtained that contains line-shaped nanostructures of U-shaped cross-section embedded within the film. Further, a portion or all of the template 11 may be removed prior to the formation of the resin film 31.

In this embodiment, by controlling the film thickness of the coating film 21 in the step of providing the coating film 21 on the surface of the template 11, the dimensions of the resulting structure can be controlled. Further, by appropriate determination of the shape of the template 11, an extremely fine structure can be produced, meaning that, for example, nanostructures composed of a coating film having a width of several nanometers to several tens of nanometers can be obtained, and the width of these structures can also be controlled with comparative ease.

Moreover, in this embodiment, a structure having a high aspect ratio can be formed on the substrate. For example, in this embodiment, a structure can be formed at a high aspect ratio (height/width) of at least 5/1, or even at 10/1 or greater. The upper limit for this aspect ratio (height/width) is preferably not more than 300/1, more preferably not more than 100/1, and still more preferably not more than 10/1.

The template 11 that is covered by the coating film 21 need not necessarily be of microscopic size, and may, for example, be a structure on the order of centimeters. By appropriate selection of the formation conditions for the coating film 21 and the removal conditions for the template 11, a nanostructure similar to that described above can still be produced. In other words, a structure having a width on the order of nanometers can still be produced.

In the embodiment described above, the steps of removing the top portion of the coating film and the step of completely removing the template are conducted separately, but the steps may be conducted simultaneously.

In the embodiment described above, the template is removed completely, but a portion may be removed and a residual portion left on the substrate.

In the above embodiment, removal of the template is conducted following removal of a portion of the coating film, but a portion or all of the template may also be removed prior to the removal of the coating film. In such a case, removal of the template can be conducted via elution, firing, or the like. Metal layers formed by electroless plating are typically porous films, meaning the type of elution treatment described above may be conducted, thereby dissolving the template within an organic solvent and removing the template.

The production method of the third aspect of the present invention (hereafter also referred to as the “production method (2)” of the present invention) includes: forming a metal nanostructure on a substrate; forming a resin film that embeds the metal nanostructure; and detaching the resin film from the substrate, wherein the step of forming the metal nanostructure on the substrate includes: at least, forming a coating film on the surface of a template provided on the substrate, the coating film including a metal layer formed by electroless plating; and removing a portion of the coating film.

The production method (2) differs from the production method (1) of the present invention in that the “template removal step” of the production method (1) is not essential, but the step of “removing a portion of the coating film” is essential.

In the production method (2) of the present invention, the step of forming the coating film and the step of removing a portion of the coating film can be conducted in the same manner as the “coating film formation step” and the “step of removing a portion of the coating film” respectively described above for the production method (1) of the present invention.

In the production method (2) of the present invention, a step of removing a portion or all of the template is preferably conducted either prior to, and/or following, the removal of a portion of the coating film.

This step may be conducted in the same manner as the “template removal step” in the production method (1) of the present invention.

In the production method (2) of the present invention, this “template removal step” is not essential, although including this step enables a finer structure to be obtained.

According to the above production method (1) or production method (2) of the present invention, a resin film can be produced that contains a nanostructure including a metal layer embedded inside the resin. For example, a nanostructure composed of a film having a width of several nanometers to several hundred nanometers, such as a nanostructure having a height of 5 to 500 nm and a width of 2 to 100 nm, and preferably a nanostructure having a height of 10 to 300 nm and a width of 1 to 50 nm, can be produced on top of a substrate with comparative ease, and as a result, a resin film that includes these types of nanostructures embedded inside the resin can also be produced with ease.

### <<Anisotropic Film Produced Using Method of Producing Anisotropic Film>>

An anisotropic film that represents the fourth aspect of the present invention is an anisotropic film produced using the aforementioned production method (1) or production method (2) of the present invention. The nanostructure within the anisotropic film must include a metal layer. Accordingly, by exposing the metal layer of the nanostructure at the film surface at two or more different portions of the nanostructure, heat or electricity can be conducted specifically from one of the locations where the metal layer is exposed through to the other location where the metal layer is exposed, using the nanostructure as a conduction medium. In those cases where the metal layer is formed inside another layer composed of a non-conductive compound, the metal layer may be exposed by suitably removing the surface of the nanostructure.

There are no particular restrictions on the shape of the nanostructure embedded inside the anisotropic film. Specific examples of shapes that can be employed include line shapes, cylindrical shapes and other three dimensional structures, as well as network structures, composite structures or repeating structures of these shapes.

For example, in the case of a line-shaped nanostructure, the anisotropic film of the fourth aspect of the present invention exhibits the same electrical conductivity anisotropy or thermal conductivity anisotropy as that described above for the anisotropic film of the first aspect of the present invention.

An anisotropic film having a line-shaped nanostructure with a U-shaped cross-section can be produced using the production method (1) or (2) of the present invention, by using a rectangular line-shaped template and forming a coating film that covers that template. The height of the inner periphery of the U-shaped cross-section of the nanostructure can be altered by adjusting the height of the template, and is preferably set within a range from 10 to 1,000 nm, and more preferably from 50 to 600 nm. Further, the width of the inner periphery of the U-shaped cross-section can be altered by adjusting the width of the template, and is preferably set within a range from 10 to 100 nm, and more preferably from 30 to 50 nm. Moreover, the width from the inner periphery to the outer periphery of the U-shaped cross-section can be altered by adjusting the thickness of the coating film, and is preferably set within a range from 10 to 100 nm, and more preferably from 50 to 70 nm.

On the other hand, an anisotropic film having a line-shaped nanostructure with a rectangular cross-section can be produced using the production method (1) or (2) of the present invention, by using a rectangular line-shaped template and removing the top portion of the coating film covering the template. The height of the rectangular cross-section of the nanostructure can be altered by adjusting factors such as the height of the template and the quantity removed from the top of the coating film, and is preferably set within a range from 10 to 1,000 nm, and more preferably from 50 to 600 nm. Further, the width of the rectangular cross-section can be altered by adjusting the thickness of the coating film, and is preferably set within a range from 10 to 100 nm, and more preferably from 50 to 70 nm.

On the other hand, by using a cylindrical nanostructure, wherein the nanostructure is positioned upright inside the resin film with the top and bottom surfaces of the metal layer of the nanostructure exposed at the two surfaces of the resin film, a resin film can be formed in which heat or electricity is able to be conducted only from the top surface to the bottom surface, or from the bottom surface to the top surface, of the nanostructure. As a result, an anisotropic film having an erect cylindrical nanostructure inside the resin film exhibits excellent anisotropy by displaying conductivity and/or thermal conductivity only in a direction perpendicular to the surface of the resin film, while having no conductivity or thermal conductivity in directions parallel to the film surface.

In addition, by positioning cylindrical nanostructures regularly within the resin film, for example by aligning the nanostructures in an erect manner, anisotropic films with various optical properties or magnetic properties can be obtained.

For example, if cylindrical nanostructures having a metal layer at the surface are positioned regularly, such as in a parallel alignment, inside a resin film, then the resulting film can be used as an optical element such as a light emitting device, a biosensor, or the like.

It is thought that the reason for this capability is that if the nanostructures are arranged regularly at the microscopic level inside the resin film, then a surface plasmon resonance effect is obtained.

Further, by forming the nanostructures that are arranged inside the anisotropic film from a material that has magnetic properties, such as nickel, an anisotropic film with magnetic properties can be produced.

Moreover, even in those cases where cylindrical nanostructures in which the metal layer does not exist at the surface are positioned regularly, such as in a parallel alignment, inside a resin film, the film can still be used as a polarizing element. It is thought that this is because the presence of the nanostructures yields a suitable degree of unevenness within the resin film.

An anisotropic film having a cylindrical nanostructure can be produced using the production method (1) or (2) of the present invention, by using a hole template or a columnar template and removing the top portion (including the uppermost surface) of the coating film covering the template. The width of the cylindrical nanostructure can be altered by adjusting factors such as the height of the template and the quantity removed from the top of the coating film, and is preferably set within a range from 100 to 1,000 nm, and more preferably from 200 to 500 nm. Further, the thickness of the cylindrical nanostructure can be altered by adjusting the thickness of the coating film, and is preferably set within a range from 10 to 100 nm, and more preferably from 50 to 70 nm.

An anisotropic film of the present invention and an anisotropic film produced using a method of producing an anisotropic film according to the present invention are films that include a nanostructure that is capable of imparting the film with anisotropy for a physical property such as the conductivity or the thermal conductivity. For example, because heat or electricity is only conducted through the nanostructure, an anisotropic film of the present invention possesses excellent anisotropy that enables heat or electricity to be transmitted only in a specific direction that corresponds with the positioning of the nanostructure. Further, because the nanostructure is an extremely fine structure, there is little chance of the nanostructure impairing the transparency of the resin film, and because the nanostructure does not impart the resin film with excessive rigidity, the film still exhibits excellent workability and handling properties. For example, an anisotropic film of the present invention can be readily cut or molded to a desired size or shape using typical methods employed for cutting or molding resin films.

In other words, an anisotropic film of the present invention and an anisotropic film produced using a method of producing an anisotropic film according to the present invention exhibit excellent levels of anisotropy and workability, and can therefore be applied to the production of microelectrodes such as the electrodes for flexible see-through solar cells and the electrodes for flexible see-through displays, and the production of actuator films and the like that expand and contract via heat or electricity.

### EXAMPLES

The present invention is described in further detail below based on a series of examples, but the present invention is in no way limited by these examples.

### Example 1

### Production of Anisotropic Film Containing Line-Shaped Gold Nanostructures Arranged in Parallel

First, a silicon wafer substrate having an organic resist (product name: TDUR-P015 PM, manufactured by Tokyo Ohka Kogyo Co., Ltd.) in which rectangular line-shaped structures having a width of approximately 400 nm and a height of approximately 700 nm had been formed by a lithography process was subjected to an oxygen plasma treatment (power: 10 W, pressure: 24 Pa, treatment time: 3 minutes), thereby reducing the size of the template to a width of approximately 200 nm and a height of approximately 350 nm, while also activating the surface of the template.

Subsequently, the substrate was dipped for two minutes in 20 ml of an aqueous solution of tin chloride (0.022 M), washed twice with deionized water, and then dried under a stream of nitrogen gas. The substrate was then dipped for 5 minutes in 20 ml of an aqueous solution of palladium chloride (0.0015 M), washed twice with deionized water, and then dried under a stream of nitrogen gas. Following completion of one repetition of this series of operations, 1 ml of an aqueous solution of dimethylamine borane (0.1 M) was added to 1 ml of a mixed aqueous solution containing nickel chloride (0.126 M) and sodium citrate (0.034 M), the resulting solution was heated to 60° C., and the substrate prepared by the operations described above was dipped in the solution for 15 seconds, thereby conducting nickel electroless plating.

Subsequently, a gold substitution plating aqueous solution product name: HGS-500, manufactured by Hitachi Chemical Co., Ltd., water: HGS-500=9:1) containing potassium cyanoaurate (0.024 M) was heated to 60° C., and the nickel electroless-plated substrate was dipped in the solution for 10 minutes, thereby conducting gold substitution plating. The resulting gold substitution plated substrate was then subjected to an etching treatment using an RIE apparatus and a mixture of argon gas and carbon tetrafluoride gas (argon gas flow rate: 30 sccm, carbon tetrafluoride gas flow rate: 5 sccm, pressure: 10 Pa, power: 100 W, treatment time: 5 minutes), thereby removing the top surface portion of the gold thin film. Subsequently, the substrate was dipped in an aqueous solution of nitric acid (10%) for 5 minutes, thereby removing the nickel. An oxygen plasma treatment (power: 10 W, pressure: 24 Pa, treatment time: 8 minutes) was then conducted to remove the template. The above operations yielded line-shaped gold nanostructures formed from the side surface portions of the gold thin film (namely, gold nanoline structures).

Subsequently, 0.1 ml of an aqueous solution of polyvinyl alcohol (10 wt %) was dropwise added onto the substrate having the gold nanoline structures and then dried. Following drying, the substrate was frozen by immersion in liquid nitrogen, and the polyvinyl alcohol film was then detached from the substrate. As a result, a film was obtained that contained the gold nanoline structures arranged in parallel inside the polyvinyl alcohol.

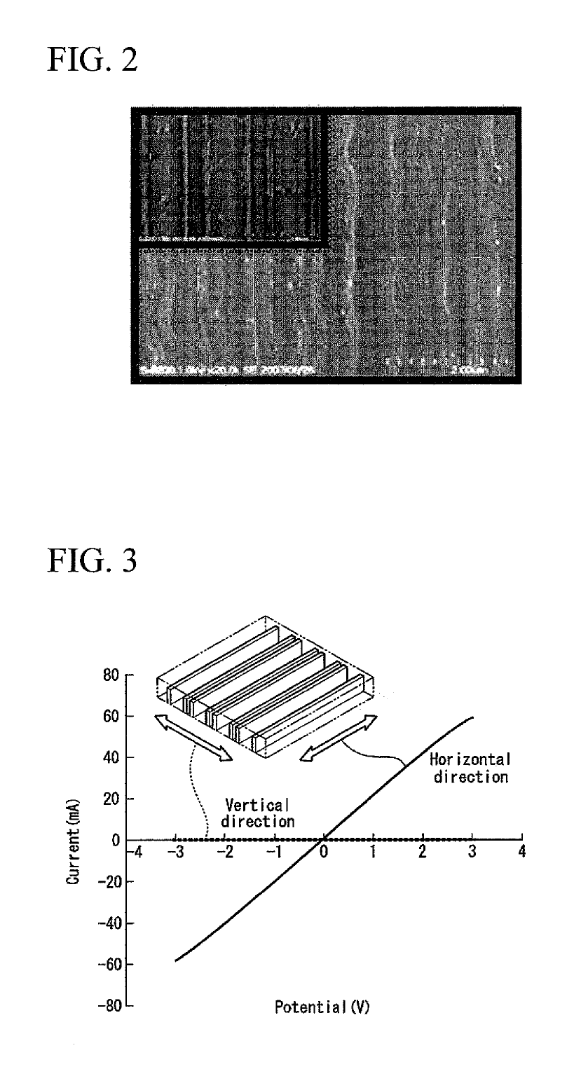

FIG. 2 is a diagram showing the results of inspecting the gold nanoline structure-containing film using a scanning electron microscope. The upper left portion of the figure represents a partially enlarged view. These results confirm that gold nanoline structures having a rectangular cross-section with a width of approximately 30 nm and a height of approximately 350 nm had been embedded in a substantially parallel arrangement within the polyvinyl alcohol film.

The conductivity of the gold nanoline structure-containing film was measured using a typical method. Specifically, a gold paste was applied to both edges of a sample of the gold nanoline structure-containing film that had been cut to a substantially square shape with a dimension of several mm, and gold wires were connected to the paste. The gold wires were then connected to a potentiostat, and the conductivity was measured across a range from −3 to 3 V by sweeping at a speed of 50 mV/second.

FIG. 3 is a graph showing the results of measuring the conductivity of the gold nanoline structure-containing film in a direction parallel to the gold nanoline structures and in a direction perpendicular to the gold nanoline structures. From these results it is evident that the gold nanoline structure-containing film exhibits conductivity in the direction parallel to the gold nanoline structures, but exhibits no conductivity in the direction perpendicular to the nanoline structures, indicating that the film exhibits excellent electrical conductivity anisotropy.

### Example 2

### Production of Anisotropic Film Containing Line-Shaped Gold Nanostructures Arranged in Parallel

First, a silicon wafer substrate having an organic resist (product name: TCIR-ZR9000 PB, manufactured by Tokyo Ohka Kogyo Co., Ltd.) in which rectangular line-shaped structures having a width of approximately 5 μm and a height of approximately 500 nm had been formed by a lithography process was subjected to an oxygen plasma treatment (power: 10 W, pressure: 24 Pa, treatment time: 3 seconds), thereby activating the surface of the template.

Subsequently, the substrate was dipped for two minutes in 20 ml of an aqueous solution of tin chloride (0.022 M), washed twice with deionized water, and then dried under a stream of nitrogen gas. The substrate was then dipped for 5 minutes in 20 ml of an aqueous solution of palladium chloride (0.0015 M), washed twice with deionized water, and then dried under a stream of nitrogen gas. This series of operations was conducted once. Subsequently, 1 ml of an aqueous solution of dimethylamine borane (0.1 M) was added to 1 ml of a mixed aqueous solution containing nickel chloride (0.126 M) and sodium citrate (0.034 M), the resulting solution was heated to 60° C., and the substrate prepared by the operations described above was dipped in the solution for 15 seconds, thereby conducting nickel electroless plating.

Subsequently, a gold substitution plating aqueous solution (product name: HGS-500, manufactured by Hitachi Chemical Co., Ltd., water: HGS-500=9:1) containing potassium cyanoaurate (0.024 M) was heated to 60° C., and the nickel electroless-plated substrate was dipped in the solution for 10 minutes, thereby conducting gold substitution plating. The resulting gold substitution plated substrate was then subjected to an etching treatment using an RIE apparatus and a mixture of argon gas and carbon tetrafluoride gas (argon gas flow rate: 30 sccm, carbon tetrafluoride gas flow rate: 5 sccm, pressure: 10 Pa, power: 100 W, treatment time: 5 minutes), thereby removing the top surface portion of the gold thin film. Subsequently, the substrate was dipped in an aqueous solution of nitric acid (10%) for 5 minutes, thereby removing the nickel. An oxygen plasma treatment (power: 10 W, pressure: 24 Pa, treatment time: 8 minutes) was then conducted to remove the template. The above operations yielded line-shaped gold nanostructures formed from the side surface portions of the gold thin film (namely, gold nanoline structures).

The substrate having these gold nanoline structures was pressed into a resin film (product name: COP, manufactured by Scivax Corporation) using an imprint apparatus (product name: X-200, manufactured by Scivax Corporation), under conditions including a mold-substrate molding temperature of 150° C., a molding pressure of 3 MPa, a molding hold time of 10 seconds, and a mold-substrate release temperature of 40° C. As a result, a gold nanoline structure-containing film containing the gold nanoline structures embedded within the resin film was obtained.

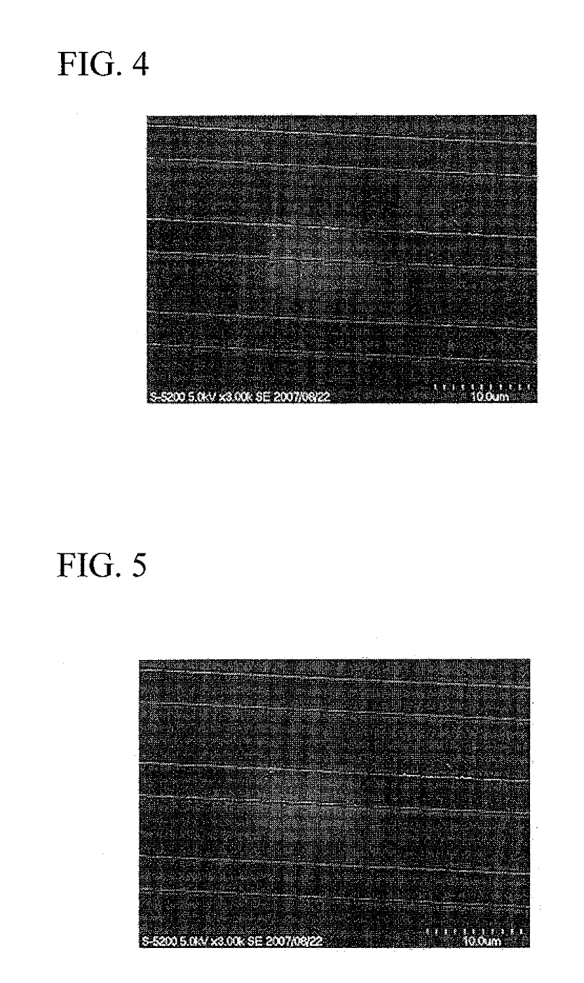

FIG. 4 is a diagram showing the results of inspecting the gold nanoline structure-containing film using a scanning electron microscope. These results confirm that gold nanoline structures having a rectangular cross-section with a width of approximately 30 nm and a height of approximately 400 nm had been embedded within the resin film.

### Example 3

### Production of Anisotropic Film Containing Line-Shaped Silver Nanostructures Arranged in Parallel

First, a silicon wafer substrate having an organic resist (product name: TCIR-ZR9000 PB, manufactured by Tokyo Ohka Kogyo Co., Ltd.) in which rectangular line-shaped structures having a width of approximately 5 μm and a height of approximately 500 nm had been formed by a lithography process was subjected to an oxygen plasma treatment (power: 10 W, pressure: 24 Pa, treatment time: 3 seconds), thereby activating the surface of the template.

Subsequently, the substrate was dipped for 5 minutes in 10 ml of an aqueous solution of silver nitrate (1 M), and was then washed for one minute with deionized water, and dried under a stream of nitrogen gas. The substrate was then dipped for one minute in 10 ml of an aqueous solution of sodium borohydride (10 mM), and was then washed for one minute with deionized water, and dried under a stream of nitrogen gas. This series of operations was conducted three times.

Subsequently, ammonia water (0.2 M) was added to 5 ml of an aqueous solution of silver nitrate (0.15 M) until the brown precipitate disappeared (approximately 5 ml), yielding a silver nitrate/ammonia mixed aqueous solution. To 1 ml of this mixed aqueous solution was added and mixed 1 ml of a glucose solution (water:methanol=7:3, 0.7 g/l), and the substrate prepared by the operations described above was then dipped in the resulting solution for 5 minutes, thereby conducting silver electroless plating. The resulting silver-plated substrate was dipped in acetone for 5 minutes to remove the template, and was then subjected to an etching treatment using an RIE apparatus and a mixture of argon gas and carbon tetrafluoride gas (argon gas flow rate: 30 sccm, carbon tetrafluoride gas flow rate: 5 sccm, pressure: 10 Pa, power: 100 W, treatment time: 20 minutes), thereby removing the top surface portion of the silver thin film. This operation yielded line-shaped silver nanostructures formed from the side surface portions of the silver thin film (namely, silver nanoline structures).

The substrate having these silver nanoline structures was pressed into a resin film (product name: COP, manufactured by Scivax Corporation) using an imprint apparatus (product name: X-200, manufactured by Scivax Corporation), under conditions including a mold-substrate molding temperature of 150° C., a molding pressure of 3 MPa, a molding hold time of 10 seconds, and a mold-substrate release temperature of 40° C. As a result, a silver nanoline structure-containing film containing the silver nanoline structures embedded within the resin film was obtained.

FIG. 5 is a diagram showing the results of inspecting the silver nanoline structure-containing film using a scanning electron microscope. These results confirm that silver nanoline structures having a rectangular cross-section with a width of approximately 50 nm and a height of approximately 400 nm had been embedded within the resin film.

### INDUSTRIAL APPLICABILITY

According to the present invention, an anisotropic film can be provided that exhibits excellent anisotropy, as well as superior workability and handling properties.

1. An anisotropic film in which a line-shaped nanostructure is disposed within a resin film.

2. The anisotropic film according to claim 1, having electrical conductivity anisotropy or thermal conductivity anisotropy.

3. A method of producing an anisotropic film comprising: forming a metal nanostructure on a substrate; forming a resin film that embeds the metal nanostructure; and detaching the resin film from the substrate, wherein
the step of forming the metal nanostructure on the substrate comprises: at least, forming a coating film on a surface of a template provided on said substrate, the coating film comprising a metal layer formed by electroless plating; and removing a portion or all of the template while retaining a portion or all of the coating film.

4. The method of producing an anisotropic film according to claim 3, wherein during the step of forming the metal nanostructure, a portion of the coating film is removed prior to removing a portion or all of the template.

5. The method of producing an anisotropic film according to claim 3, wherein during the step of forming the metal nanostructure, a portion of the coating film is removed following removing a portion or all of the template.

6. The method of producing an anisotropic film according to claim 5, wherein during the step of forming the metal nanostructure, a portion of the coating film is removed following removing a portion of the template.

7. The method of producing an anisotropic film according to claim 3, wherein during the step of forming the metal nanostructure, a removed portion of the coating film is a top portion of said coating film.

8. The method of producing an anisotropic film according to claim 3, wherein during the step of forming the metal nanostructure, the electroless plating is conducted after introduction of an electroless plating catalyst at a surface of said template.

9. The method of producing an anisotropic film according to claim 3, wherein during the step of forming the metal nanostructure, a hydrophilic treatment is performed on a surface of the template prior to forming the metal layer.

10. The method of producing an anisotropic film at claim 9, wherein the hydrophilic treatment is an oxygen plasma treatment.

11. The method of producing an anisotropic film according to claim 3, wherein the step of forming the resin film comprises applying a resin solution onto the substrate, and forming a resin film that embeds said metal nanostructure.

12. The method of producing an anisotropic film according to claim 3, wherein a metal of the metal layer is gold or silver.

13. The method of producing an anisotropic film according to claim 3, wherein the template is composed of a template-forming material comprising an organic compound with a molecular weights of at least 500.

14. The method of producing an anisotropic film according to claim 13, wherein the template-forming material is a resist composition.

15. A method of producing an anisotropic film comprising: forming a metal nanostructure on a substrate; forming a resin film that embeds the metal nanostructure; and detaching the resin film from the substrate, wherein
the step of forming the metal nanostructure on the substrate comprises: at least, forming a coating film on a surface of a template provided on the substrate, the coating film comprising a metal layer formed by electroless plating; and removing a portion of said coating film.

16. The method of producing an anisotropic film according to claim 15, wherein the removed portion of the coating film is a top portion of said coating film.

17. The method of producing an anisotropic film according to either claim 15, wherein during the step of forming the metal nanostructure, a portion or all of the template is removed, either prior to and/or following removing a portion of the coating film.

18. The method of producing an anisotropic film according to claim 15, wherein during the step of forming the metal nanostructure, the electroless plating is conducted after introduction of an electroless plating catalyst at a surface of said template.

19. The method of producing an anisotropic film according to claim 15, wherein during the step of forming the metal nanostructure, a hydrophilic treatment is performed on a surface of the template prior to forming the metal layer.

20. The method of producing an anisotropic film at claim 19, wherein the hydrophilic treatment is an oxygen plasma treatment.

21. The method of producing an anisotropic film according to claim 15, wherein the step of forming the resin film comprises applying a resin solution onto the substrate, and forming a resin film that embeds said metal nanostructure.

22. The method of producing an anisotropic film according to claim 15, wherein a metal of the metal layer is gold or silver.

23. The method of producing an anisotropic film according to claim 15, wherein the template is composed of a template-forming material comprising an organic compound with a molecular weight of at least 500.

24. The method of producing an anisotropic film according to claim 23, wherein the template-forming material is a resist composition.

25. An anisotropic film produced using the method of claim 3 or claim 15.

26. The anisotropic film according to claim 25, having electrical conductivity anisotropy or thermal conductivity anisotropy.
